(19) United States
(12) Patent Application Publication
(10) Pub. No.: US 2025/0315226 A1
(43) Pub. Date: Oct. 9, 2025

(54) EDGE DEVICE WITH BUILT-IN COMPILER FOR NEURAL NETWORK MODELS

(71) Applicant: DEEPX CO., LTD., Seongnam si (KR)

(72) Inventors: Lok Won KIM, Yongin-si (KR); Bon Gyu KOO, Seongnam-si (KR)

(21) Appl. No.: 18/657,735

(22) Filed: May 7, 2024

(30) Foreign Application Priority Data
Apr. 8, 2024 (KR) 10-2024-0047283

(51) Int. Cl. G06F 8/41

(52) U.S. Cl. CPC G06F 8/41

(57) ABSTRACT

A system includes a substrate on which a first memory, a neural processing unit (NPU) including a plurality of processing elements (PEs) with multiplier-accumulator circuits, a controller, and a second memory, and a central processing unit (CPU) are disposed. The CPU may be configured to execute a universal compiler to perform a conversion for a particular neural network model into a machine code executable by the NPU and store the machine code in the first memory or the second memory. When the particular neural network model, generated by one among a plurality of machine learning frameworks that are incompatible with each other, is received and stored in the first memory, the universal compiler may perform the conversion based on mapping information indicating mapping between elements of machine learning frameworks and functions or operations executable by the CPU or NPU.

### CROSS-REFERENCE TO RELATED APPLICATIONS

This application claims priority to Republic of Korea Patent Application No. 10-2024-0047283 filed on Apr. 8, 2024, in the Korean Intellectual Property Office, the disclosures of which are incorporated herein by reference.

### BACKGROUND OF THE DISCLOSURE

### Technical Field

Present disclosures relate to techniques for compiling neural network models.

### Background Art

Artificial intelligence (AI) is also gradually developing. AI refers to the branch of computer science that aims to create systems capable of performing tasks that would normally require human intelligence. These tasks include learning from experiences, understanding and processing language, recognizing patterns, and making decisions. AI is built upon algorithms and data to simulate aspects of human cognition, and it finds applications in various fields such as healthcare, finance, automotive, and more, fundamentally altering how tasks are approached and completed in many industries.

In recent years, neural processing units (NPUs) have been developed to accelerate the speed of computation for AI. An NPU is a specialized hardware component designed specifically to accelerate the processing of AI tasks. NPUs are suitable for the high-speed execution of neural network operations, which are fundamental to many AI algorithms, enabling faster data processing and reduced power consumption compared to general-purpose CPUs. These units are increasingly integrated into devices like smartphones, tablets, and edge computing devices to enhance their ability to perform tasks such as image recognition, and natural language processing more efficiently.

### SUMMARY OF THE DISCLOSURE

Embodiments relate to an integrated circuit including: a neural processing unit (NPU) including a plurality of processing elements (PEs); a central processing unit (CPU) coupled to the NPU; and one or more memory circuits coupled to the NPU and the CPU. Each of the PEs includes a multiplier-accumulator circuit configured to perform multiply-accumulate operations. The one or more circuits stores instructions that cause the CPU to: compile a first neural network model of a first machine learning framework incompatible with the NPU into first machine code executable by the NPU, according to first mapping information, store the first machine code, and send the first machine code to the NPU for execution. The first mapping information represents mapping of elements of the first machine learning framework to functions or operations executable by at least one of the NPU or the CPU.

In one or more embodiments, the instructions, when executed by the CPU, cause the CPU to: compile a second neural network model of a second machine learning framework incompatible with the NPU into second machine code executable by the NPU, according to second mapping information representing mapping of elements of the second machine learning framework to the functions or operations executable by at least one of the NPU or the CPU, store the second machine code, and send the second machine code to the NPU for execution

In one or more embodiments, the configuration of the NPU further includes at least one of: an internal memory size of the NPU; a bitwidth of read or write operations associated with the one or more memory circuit; a type, structure or speed of the one or more memory circuit; types of number formats supported by the NPU; a range of bitwidth supported for integer operations or floating-point operations; an operating frequency of the NPU; a number of the plurality of Pes; or capability of special function unit circuits in the NPU. In one or more embodiments,

In one or more embodiments, the instructions causing the CPU to compile the first neural network model into the first machine code cause the CPU to convert the first neural network model into a framework-independent model, convert the framework-independent model into a hardware-independent graph, convert the hardware-independent model into a hardware-dependent code, and convert the hardware-dependent code into the first machine code.

In one or more embodiments, the instructions to compile the first neural network cause the CPU to perform at least one of optimizing or verification of the machine code.

In one or more embodiments, the instructions to optimize the machine code cause the CPU to perform at least one of: perform pruning, perform quantization, perform retraining, perform compression, perform an artificial intelligence (AI)-based optimization algorithm, or perform knowledge distillation.

In one or more embodiments, the instructions to compile the first neural network cause the CPU to analyze parameter information of each layer of the first neural network model.

In one or more embodiments, the instructions to compile the first neural network cause the CPU to analyze sizes of weight parameters and feature map parameters of each layer in the first neural network model.

In one or more embodiments, the instructions to compile the first neural network cause the CPU to analyze connectivity between layers in the first neural network model.

### BRIEF DESCRIPTION OF THE DRAWINGS

FIG. 1 is a conceptual diagram illustrating an example neural network model.

FIG. 2A is a drawing to illustrate the basic structure of a convolutional neural network (CNN).

FIG. 2B is a diagram illustrating the behavior of a convolutional neural network.

FIG. 3 is a conceptual diagram illustrating a neural processing unit (NPU) according to one embodiment.

FIG. 4A is a conceptual diagram illustrating a processing element of one of a plurality of processing elements, according to one embodiment.

FIG. 4B is a conceptual diagram illustrating a special function unit (SFU), according to one embodiment.

FIG. 5 is a diagram an NPU, according to another embodiment.

FIG. 6 is a diagram depicting a neural network model optimization unit and an edge device, according to one embodiment.

FIG. 7 is a block diagram illustrating a configuration of a neural network model performance evaluation system, according to another embodiment.

FIG. 8 is a block diagram illustrating a configuration of the neural network model optimization device of FIG. 7, according to one embodiment.

FIG. 9 is a block diagram illustrating a configuration of the compiler in FIG. 8, according to one embodiment.

FIG. 10 is a block diagram illustrating a configuration of the optimizer in FIG. 9, according to one embodiment.

FIG. 11A is a block diagram illustrating a plurality of neural processing units of a neural network model processing device and an interface for selecting compilation options, according to one embodiment.

FIG. 11B is a block diagram illustrating an interface for performance evaluation and suggestions for a plurality of neural processing units of a neural network model processing device, according to one embodiment.

FIGS. 12A to 12D are block diagrams illustrating a configuration of one neural processing unit of a neural network model optimization devices, according to another embodiment.

FIG. 13 is a block diagram illustrating a configuration of a plurality of neural processing units, according to another embodiment.

FIGS. 14A to 14C are example diagrams illustrating reasons for providing a dedicated compiler, according to one embodiment.

FIGS. 15A to 15C are block diagrams illustrating an edge device including an integrated compiler, according to embodiments.

FIG. 15D is an example diagram illustrating the edge device of FIG. 15C, according to another embodiment.

### DETAILED DESCRIPTION OF THE EMBODIMENT

Certain structural or step-by-step descriptions of the examples of the present disclosure are intended only to illustrate examples according to the concepts of the present disclosure. Accordingly, the examples according to the concepts of the present disclosure may be practiced in various forms. Examples according to the concepts of the present disclosure may be implemented in various forms. The present disclosure should not be construed as limiting to the examples of this disclosure.

Various modifications can be made to the examples according to the concepts of the present disclosure and can take many different forms. Accordingly, certain examples have been illustrated in the drawings and described in detail in the present disclosure or application. However, this is not intended to limit the examples according to the present disclosure to any particular disclosure form. The present disclosure according to the concepts of the present disclosure should be understood to include all modifications, equivalents, or substitutions that fall within the scope of the ideas and techniques of the present disclosure.

Terms such as first and/or second may be used to describe various elements, but the elements are not to be limited by the terms. The terms may be used only to distinguish one element from another. Without departing from the scope of the rights under the concepts of the present disclosure, a first elements may be named as a second elements, and similarly, a second elements may be named as a first elements.

When an elements is referred to as being “connected” or “plugged in” to another element, it may be directly connected or connected to the other element. However, it should be understood that other elements may exist in the middle of the plurality of elements. On the other hand, when an elements is the to be “directly connected” or “directly connected” to another element, it should be understood that there are no other elements in between. Other expressions describing relationships between elements, such as “between” and “directly between” or “adjacent to” and “directly adjacent to” should be interpreted similarly.

The terminology used in this disclosure is intended only to describe specific examples and is not intended to limit the present disclosure. Expressions in the singular include the plural unless the context clearly indicates otherwise. In the present disclosure, terms such as “includes” or “has” are intended to designate the presence of a described feature, number, step, action, element, part, or combination thereof, and should be understood as not precluding the possibility of the presence or addition of one or more other features, numbers, steps, actions, elements, parts, or combinations thereof.

### Example Neural Networks

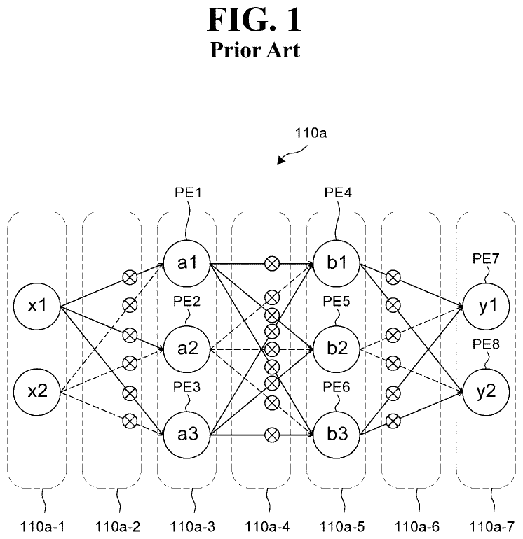

FIG. 1 is a schematic diagram illustrating an example neural network model, according to one embodiment. Hereinafter, operations of an example neural network model 110a that can be operated in the neural processing unit 100 will be described. The example neural network model 110a of FIG. 1 may be an artificial neural network trained to perform various inference functions such as object recognition, speech recognition, etc. The neural network model 110a may be a deep neural network (DNN). However, the neural network model 110a according to examples of the present disclosure is not limited to a deep neural network. For example, the neural network model 110a may be LLM, Generative Adversarial Networks (GAN), Florence-2, DaViT, MobileViT, ViT, Swin-Transformer, Transformer, YOLO, CNN, PIDNet, BiseNet, RCNN, VGG, VGG16, DenseNet, SegNet, DeconvNet, DeepLAB V3+, U-net, SqueezeNet, Alexnet, ResNet18, MobileNet-v2, GoogLeNet, Resnet-v2, Resnet50, Resnet101, Inception-v3, and other models. However, the present disclosure is not limited to the models described above. The neural network model 110a may also be an ensemble model based on at least two different models.

In the following, an inference process performed by the example neural network model 110a will be described. The neural network model 110a is an example deep neural network model including an input layer 110a-1, a first connection network 110a-2, a first hidden layer 110a-3, a second connection network 110a-4, a second hidden layer 110a-5, a third connection network 110a-6, and an output layer 110a-7. However, the present disclosure is not limited to the neural network model shown in FIG. 1. The first hidden layer 110a-3 and the second hidden layer 110a-5 may also be referred to as a plurality of hidden layers.

The input layer 110a-1 may include, for example, x1 and x2 input nodes, i.e., the input layer 110a-1 may include information about two input values. The first connection network 110a-2 may include six weight values for connecting each node of the input layer 110a-1 to each node of the first hidden layer 110a-3. Each weight value is multiplied with the input node value, and an accumulated value of the multiplied values is stored in the first hidden layer 110a-3. The weight values and input node values may be referred to as parameters of the neural network model herein.

The first hidden layer 110a-3 may exemplarily include a1, a2, and a3 nodes, i.e., the first hidden layer 110a-3 may include information about three node values. The first processing element PE1 of FIG. 1 may process operations on the a1 node. The second processing element PE2 of FIG. 1 may process the operations of the a2 node. The third processing element PE3 of FIG. 1 may process the operations of the a3 node. The second connection network 110a-4 may include, for example, information about nine weight values for connecting each node of the first hidden layer 110a-3 to each node of the second hidden layer 110a-5. The weight values of the second connection network 110a-4 are each multiplied with the node values input from the first covert layer 110a-3, and the accumulated value of the multiplied values is stored in the second covert layer 110a-5. The second hidden layer 110a-5 may exemplarily include nodes b1, b2, and b3, i.e., the second hidden layer 110a-5 may include information about three node values. The fourth processing element PE4 of FIG. 1 may process operations on the b1 node. The fifth processing element PE5 of FIG. 1 may process the operations of the b2 node. The sixth processing element PE6 of FIG. 1 may process the operations of node b3. The third connection network 110a-6 may include information about six weight values that connect each node of the second hidden layer 110a-5 with each node of the output layer 110a-7, for example. The weight values of the third connection network 110a-6 are each multiplied with the node values input from the second hidden layer 110a-5, and the accumulated value of the multiplied values is stored in the output layer 110a-7.

The output layer 110a-7 may include nodes y1, and y2, i.e., the output layer 110a-7 may include information about two node values. The seventh processing element PE7 of FIG. 1 may process operations on the y1 node. The eighth processing element PE8 of FIG. 1 may process the operation of the y2 node. Each node may correspond to a feature value, and the feature value may correspond to a feature map (i.e., an activation parameter).

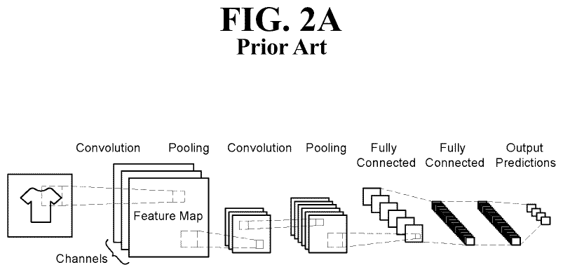

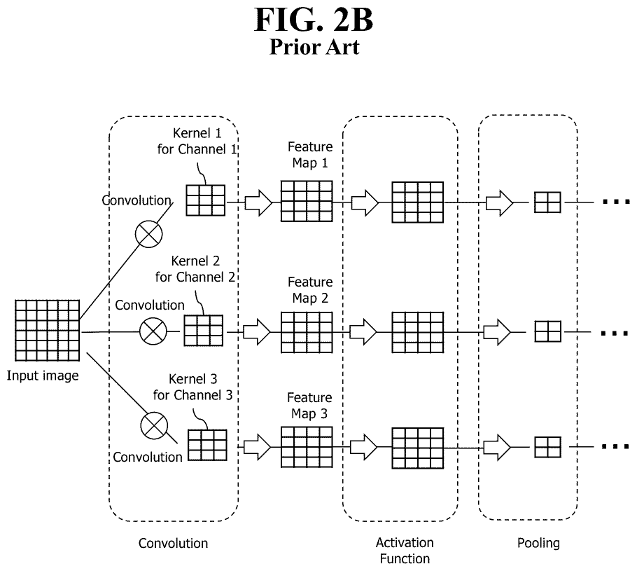

FIG. 2A is a diagram to illustrate the basic structure of a convolutional neural network (CNN). Referring to FIG. 2A, an input image may be represented as a two-dimensional matrix comprising rows of a particular size and columns of a particular size. When using the processing an image as an example, the input image may have a plurality of channels, where the channels may represent the number of color components of the input data image. The process of convolution involves a kernel traversing the input image at specified intervals. The CNN may pass the output value (e.g., a convolution result or a matrix multiplication) of the current layer as the input value of the next layer. For example, a convolutional or matrix multiplication is defined by two main parameters: the input feature map and the kernel. Parameters can include input feature map, output feature map, activation map, weights, kernel, and attributes (Q, K, V),

The convolution slides a kernel window over the input feature map. The size of the step by which the kernel slides over the input feature map is called the stride. After convolution, pooling may be applied. In addition, a fully-connected (FC) layer may be placed at the end of the convolutional neural network.

For the sake of simplicity, convolutional operations will be discussed below, but other operations such as matrix multiplication can be included in specific layers of a neural network model.

FIG. 2B is a diagram illustrating the operation of a convolutional neural network. Referring to FIG. 2B, it is shown that an example input image is a two-dimensional matrix with a size of 6×6. Also, in FIG. 2B, three nodes are exemplarily used, namely channel 1, channel 2, and channel 3.

First, the convolutional behavior is described. The input image (exemplarily shown as 6×6 in FIG. 2B) is convolved with kernel 1 (exemplarily shown as 3×3 in FIG. 2B) for channel 1 at the first node, and feature map 1 (exemplarily shown as 4×4 in FIG. 2B) is output as a result. Further, the input image (exemplarily represented in FIG. 2B as 6×6 in size) is convolved with a kernel 2 (exemplarily represented in FIG. 2B as 3×3 in size) for channel 2 at a second node, and feature map 2 (exemplarily represented in FIG. 2B as 4×4 in size) is output as a result. Further, the input image is convolved with a kernel 3 (exemplarily represented in FIG. 2B as being 3×3 in size) for channel 3 at the third node, and a feature map 3 (exemplarily represented in FIG. 2B as being 4×4 in size) is output as a result.

To process each convolution, the processing elements PE1 to PE12 of the neural processing unit 100, each includes at least one multiplier-accumulator circuit that performs multiply-accumulate (MAC) operations.

Then, the activation function may be applied to the feature map 1, feature map 2, and feature map 3 (each of which is shown in FIG. 2B as having an example size of 4×4) output from the convolutional operation. The output after the activation function is applied may be an example size of 4×4.

The pooling operation may then be performed. Feature map 1, feature map 2, and feature map 3 (each of which is exemplarily 4×4 in FIG. 2B), which are output from the above activation function, are input to three nodes. By taking the feature maps output from the activation function as input, pooling can be performed. The pooling is performed to reduce the size or to emphasize certain values in a feature map. Pooling methods include maximum value pooling, average pooling, and minimum value pooling. Maximum pooling selects a maximum values within a certain part of the feature map, average pooling computes and uses an average the values within the certain part of the feature map, and minimum pooling selects a minimum value within a certain part of the feature map.

In the example of FIG. 2B, a feature map of size 4×4 is shown to be reduced to a size of 2×2 by pooling. Specifically, the first node takes as input the feature map 1 for channel 1, performs pooling and outputs, for example, a 2×2 matrix. The second node takes as input the feature map 2 for channel 2, performs the pooling, and outputs, for example, a 2×2 matrix. The third node takes as input the feature map 3 for channel 3, performs pooling and outputs, for example, a 2×2 matrix.

The aforementioned convolution, activation function, and pooling are repeated, and finally, the output can be fully connected as shown in FIG. 2A.

### Hardware Resources Associated with Neural Network

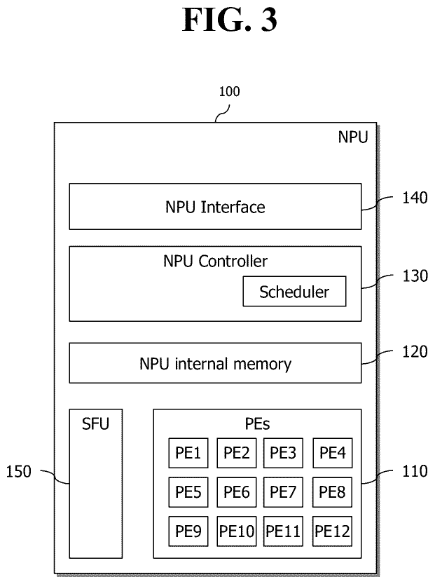

FIG. 3 is a schematic diagram illustrating a neural processing unit according to an example of the present disclosure. The neural processing unit (NPU) 100 illustrated in FIG. 3 is a processor specialized to perform operations for a neural network. The neural processing unit 100 may be embodied as an integrated circuit that includes multiple discrete circuits. These multiple discrete circuits may be formed on a common semiconductor substrate, and each of the discrete circuits may include electronic elements such as transistors and capacitors.

In the case of a neural network model based on a ViT, transformer, and/or CNN, the neural processing unit 100 may perform matrix multiplication operations, convolutional operations, and the like, depending on the graph structure of the neural network.

For example, in each layer of a convolutional neural network (CNN), the input feature map corresponding to the input data and the kernel corresponding to the weights may be a tensor or matrix comprising a plurality of channels. A convolutional operation is performed on the input feature map and the kernel, and a convolutional operation and pooled output feature map are generated per each channel. An activation function is applied to the output feature map to generate an activation map for that channel. Pooling can then be applied to the activation map. The activation map may be collectively referred to herein as the output feature map. For convenience in the following description, the activation map will be referred to as the output feature map. However, the examples of the present disclosure are not limited thereto, and the output feature map may be subjected to a matrix multiplication operation or a convolution operation.

Furthermore, the output feature map according to the examples of the present disclosure should be interpreted in a comprehensive sense. For example, the output feature map may be the result of a matrix multiplication operation or a convolution operation. Accordingly, the plurality of processing elements 110 may be modified to further include processing circuitry for additional algorithms, such that some circuit units of the SFU 150, which will be described later, may be configured to be included in the plurality of processing elements 110.

The neural processing unit 100 may be configured to include a plurality of processing elements 110 for processing convolutional and matrix multiplications used in the neural network operations described above.

The neural processing unit 100 may be configured to include dedicated circuits for performing, among other operations, matrix multiplication operations, convolutional operations, activation function operations, pooling operations, stride operations, batch normalization operations, skip connection operations, concatenation operations, quantization operations, clipping operations, and padding operations associated with the above-described neural network operations. For example, the neural processing unit 100 may be configured to include a special function unit (SFU) 150 for performing at least one of the following functions processing at least one of the above algorithms: activation function operation, pooling operation, stride operation, batch normalization operation, skip connection operation, concatenation operation, quantization operation, clipping operation, and padding operation.

Specifically, the neural processing unit 100 is embodied as an integrated circuit including a plurality of processing elements (PEs) 110, SFU 150, NPU internal memory 120, NPU controller 130, and NPU interface 140. Each of the plurality of processing elements 110, SFU 150, NPU internal memory 120, NPU controller 130, and NPU interface 140 may be a semiconductor circuit with many connected transistors.

The NPU controller 130 may function as a control unit that controls and coordinates the overall operations of components of the neural processing unit 100. For example, NPU controller 130 may control a computation schedule of the plurality of processing elements 110, the SFU 150, and the NPU internal memory 120.

The neural processing unit 100 may include an NPU internal memory 120 configured to store parameters (e.g., weight values, feature maps, input node values) of a neural network model that may be loaded onto the plurality of processing elements 110 and/or the SFU 150 for computation.

The neural processing unit 100 may be configured to process feature maps in response to encoding and decoding schemes using scalable video coding (SVC) or scalable feature map coding (SFC). The above methods are techniques for variably varying the amount of data transmission based on the effective bandwidth and signal to noise ratio (SNR) of the communication channel or communication bus. That is, the neural processing unit 100 may also function as an encoder and a decoder for SVC or SFC.

The plurality of processing elements 110 may perform some of the operations for the neural network while the SFU 150 may perform other portions of the operations for the neural network.

The neural processing unit 100 may be configured to hardware accelerate computation of the neural network model using the plurality of processing elements 110 and the SFU 150.

The NPU interface 140 may communicate with various elements connected to the neural processing unit 100, such as memory, via a system bus.

The NPU controller 130 may be configured to control the order of operations of the plurality of processing elements 110, the SFU 150, and reads and writes to the NPU internal memory 120 for operations of the neural processing unit 100.

The NPU controller 130 may be configured to control the plurality of processing elements 110, the SFU 150, and the NPU internal memory 120 based on information about data locality or the structure of the neural network model.

The NPU controller 130 may analyze the structure of the neural network model to be operated on the plurality of processing elements 110 and SFU 150, or may be provided with information that has already been analyzed. The analyzed information may be information generated by a compiler, which is software typically executed on a separate computing device external to the neural processing unit 100. For example, the data of the neural network that the neural network model may include may include at least some of the following: node data of each layer (i.e., feature map), batch data of the layers, locality information or information about the structure, and weight data (i.e., weight kernel) of each of the connection networks connecting the nodes of each layer. The data of the neural network may be stored in memory provided within the NPU controller 130 or in the NPU internal memory 120. However, without limitation, the data of the neural network may be stored in a separate cache memory or register file provided in the NPU or outside the NPU in another component of the integrated circuit.

The NPU controller 130 may obtain scheduling information indicating the order of operations of the neural network model to be performed by the neural processing unit 100 based on a directed acyclic graph (DAG) of the neural network model compiled by the compiler.

The NPU controller 130 may be provided with scheduling information of a sequence of operations of the neural network model to be performed by the neural processing unit 100 based on information about data locality and/or structure of the compiled neural network model. For example, the scheduling information may be information generated by the compiler. The scheduling information generated by the compiler may be in the form of machine code, binary code, or the like.

In other words, the scheduling information utilized by the NPU controller 130 may be information generated by the compiler based on the data locality information or the structure of the neural network model. The compiler may efficiently schedule the NPU to reconstruct the neural network data locality, which is a unique property of the neural network model. Additionally, the compiler can efficiently schedule the NPU based on the hardware architecture and performance of the neural processing unit 100. Additionally, when the neural network model is compiled by the compiler to be executed on the neural processing unit 100, the neural network data locality may be reconstructed. The neural network data locality may be reconfigured based on the algorithms applied to the neural network model and the operational characteristics of the processor. Further, the neural network data locality may be reconstructed based on how the neural processing unit 100 processes the neural network model, e.g., feature map tiling, stationary processing of processing elements, etc. Additionally, the neural network data locality may be reconfigured based on the number of processing elements in the neural processing unit 100, the capacity of the internal memory, and the like. Furthermore, the neural network data locality may be reconfigured based on the bandwidth of the memory communicating with the neural processing unit 100. Consideration of these factors may result in a different order of data for processing at different cycles despite embodying the same neural network model.

The compiler may determine the order of data associated with the neural network model to be loaded and computed according to the order of operation of the layers, unit convolutions, and/or matrix multiplications of the artificial neural network. The order of data may be used to determine data locality and to generate the compiled machine code.

The machine code may be executed by the NPU controller 130 to coordinate the operations of components in NPU 100 according to the determined order of data. Based on the scheduling information, the NPU controller 130 may obtain memory address values in NPU internal memory 120 where the feature map and weight data of the layers of the neural network model are stored.

For example, the NPU controller 130 may obtain the memory address value at which the feature maps (i.e., activations) and weight data of the layers of the neural network model are stored in the memory. Thus, the NPU controller 130 may fetch the feature maps and weight data of the layers of the neural network model to be executed from the main memory and store them in the NPU internal memory 120.

Based on the data locality information of the neural network model, the neural processing unit 100 may set a memory map of the main memory for efficient read/write operations of the parameters (e.g., weights and feature maps) of the neural network model to reduce the latency of data transmission between the main memory and the NPU internal memory 120.

Each layer's feature map can have a corresponding memory address value. Each weight data may have a corresponding respective memory address value.

The NPU controller 130 may be provided with scheduling information about the order of operations of the plurality of processing elements 110 based on information about data locality or structure of the neural network model, such as batch data of layers of the neural network of the neural network model, locality information, or information about structure. The scheduling information may be generated in a compilation step.

Because the NPU controller 130 operates based on scheduling information determined from data locality or structure of the neural network model, it may operate differently from the scheduling concepts of a typical CPU. The scheduling of a conventional CPU operates to achieve the best efficiency by considering fairness, efficiency, stability, and response time. In a conventional CPU, the scheduling focuses on performing the most amount of processing to in the same amount of time by considering priority, computation time, and the like. For this purpose, conventional CPUs use algorithms to schedule tasks by considering data such as the priority of each task and the processing time of the task.

In contrast, the NPU controller 130 can control the neural processing unit 100 in a processing order of the neural processing unit 100 determined based on information about data locality or structure of the neural network model. Further, the NPU controller 130 may control the neural processing unit 100 in a processing order determined based on the information about the data locality information or structure of the neural network model and/or the information about the data locality information or structure of the neural processing unit 100 to be used. Hence, caching strategies (e.g., Least Recently Used (LRU), First In First Out (FIFO), Least Frequently Used (LFU)) used in Von Neumann structures are inefficient for controlling the NPU internal memory 120 of the neural processing unit 100. Since the neural network model has a directed acyclic graph (DAG) algorithmic structure rather than a simple chain-structured algorithm, the operation of the neural processing unit 100 is efficient with a caching strategy that recognizes the data locality of the neural network model. However, the present disclosure is not limited to information about data locality or structure of the neural processing unit 100.

The NPU controller 130 may be configured to store information about the data locality information or structure of the neural network. In other words, the NPU controller 130 can determine the processing order by utilizing at least the information about the data locality information or structure of the neural network of the neural network model.

Further, the NPU controller 130 may determine the processing order of the neural processing unit 100 by considering information about the data locality information or structure of the neural network model and information about the data locality information or hardware structure of the neural processing unit 100. Furthermore, processing at the neural processing unit 100 may be enhanced when its operations are performed in a determined order. In some examples, the NPU controller 130 may be configured to operate based on machine code compiled from a compiler. But in other examples, the NPU controller 130 may be configured to include an embedded compiler. According to the configurations described above, the neural processing unit 100 may be configured to generate machine code by receiving input files in the form of frameworks of various AI software. For example, AI software frameworks include TensorFlow, Py Torch, Keras, XGBoost, mxnet, DARKNET, ONNX, and the like.

The plurality of processing elements 110 refers to a plurality of processing elements (PE1 to PE12) configured to compute the feature map and weight data of the artificial neural network. Each processing element may include a multiply and accumulate (MAC) operator and/or an arithmetic logic unit (ALU) operator. However, examples according to the present disclosure are not limited thereto.

Each processing element may be configured to optionally further include additional SFU circuitry to handle additional specialized functions. For example, the processing element PE may be modified to further include a batch-regularization unit, an activation function unit, an interpolation unit, and the like. The SFU 150 may include one or more circuits to perform, for example, the following operations: for skip-connection operations, applying activation function, pooling operations, dequantization operations, quantization operations, and non-maximum suppression (NMS) operations, a batch-normalization operation, an interpolation operation, a concatenation operation, and a bias operation, which may be selected according to the graph module of the neural network model. In other words, the SFU 150 may include a plurality of specialized functional computation processing circuits. The SFU 150 may include circuitry to process various operations that a processing element may not perform efficiently.

While FIG. 3 shows a plurality of processing elements as an example, a plurality of operators implemented as a plurality of multiplier and adder trees in parallel may be used instead to replace the MAC within a single processing element. In such cases, processing elements 110 may be include a processing element with a plurality of operators.

The plurality of processing elements 110 is configured to include a plurality of processing elements PE1 to PE12. The plurality of processing elements PE1 to PE12 shown in FIG. 3 are illustrative only, and the number of the plurality of processing elements PEI to PE12 is not limited. The number of the plurality of processing elements PE1 to PE12 may determine the size or number of the plurality of processing elements 110. The size of the plurality of processing elements 110 may be implemented in the form of an N×M matrix, where N and M are integers greater than zero. The plurality of processing elements 110 may include N×M processing elements. The number of processing elements 110 can be designed taking into account the characteristics of the neural network model in which the neural processing unit 100 operates. The processing elements 110 are configured to perform functions such as addition, multiplication, accumulation, and the like that are necessary for computing the neural network. In other words, the plurality of processing elements 110 may be configured to perform multiplication and accumulation (MAC) operations.

Hereinafter, a first processing element PEI of the plurality of processing elements 110 will be described by way of example.

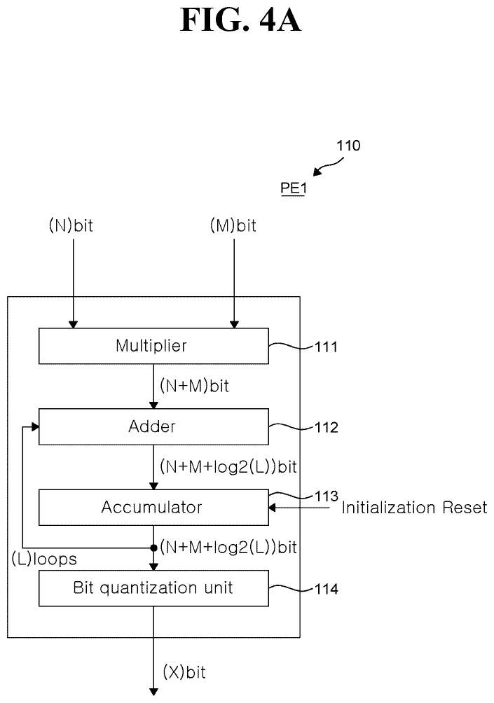

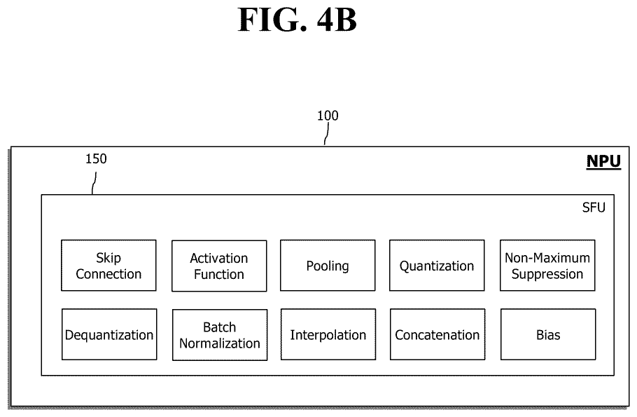

FIG. 4A is a schematic diagram illustrating a processing element of a plurality of processing elements that may be applicable to an example of the present disclosure. A neural processing unit 100 according to an example of the present disclosure may include a plurality of processing elements 110, an NPU internal memory 120 configured to store a neural network model that may be inferred by the plurality of processing elements 110, and an NPU controller 130 configured to control the plurality of processing elements 110 and the NPU internal memory 120, the plurality of processing elements 110 configured to perform MAC operations, and the plurality of processing elements 110 configured to quantize and output results of the MAC operations. However, examples of the present disclosure are not limited thereto.

The NPU internal memory 120 may store all or part of the parameters associated with neural network model depending on the memory size and the data size of the neural network model.

The first processing element PEI may include a multiplier 111, an adder 112, an accumulator 113, and a bit quantization unit 114. However, examples according to the present disclosure are not limited, and the plurality of processing elements 110 may be modified to account for the computational characteristics of the artificial neural network.

The multiplier 111 multiplies the input N-bit data and the M-bit data. The result of the operation of the multiplier 111 is output as (N+M)-bit data. The multiplier 111 may be configured to receive one weight parameter and one feature map parameter as input. The multiplier 111 may be configured to operate in a zero skipping manner when a value of zero for a parameter is input to one of the inputs of the first input and the second input of the multiplier 111. In such a case, the multiplier 111 may be disabled when the multiplier 111 receives an input of a weight parameter or feature map parameter having a value of zero. Thus, the multiplier 111 may be configured to reduce power consumption of the plurality of processing elements 110 when processing a weight parameter with a pruning algorithm applied, or when the feature map parameter has a value of zero. Accordingly, the processing element including the multiplier 111 may be disabled.

The accumulator 113 accumulates the operation value of the multiplier 111 and the operation value of the accumulator 113 using the adder 112 for a number of L-loops. Thus, the bit width of the data at the output and input of the accumulator 113 may be output as (N+M+log2(L))bit, where L is an integer greater than zero. When the accumulator 113 finishes accumulating, the accumulator 113 may receive an initialization signal (initialization reset) to initialize the data stored inside the accumulator 113 to zero. However, the examples according to the present disclosure are not limited thereto.

The bit quantization unit 114 may reduce the bit width of the data output from the accumulator 113. The bit quantization unit 114 may be controlled by the NPU controller 130. The bit width of the quantized data may be output as X-bit, where X is an integer greater than zero. According to the configuration described above, the plurality of processing elements 110 are configured to perform a MAC operation, and the plurality of processing elements 110 output quantized versions of the MAC operation results. In particular, this quantization has the effect of further reducing power consumption as the number of L-loops increases. Also, reducing power consumption has the effect of reducing heat generation. In particular, reducing heat generation has the effect of reducing the possibility of malfunctions caused by high temperatures in the neural processing unit 100.

The output data X-bit of the bit quantization unit 114 can be the node data of the next layer or the input data of the convolutional processor. If the neural network model is quantized, the bit quantization unit 114 may be configured to receive the quantized information from the neural network model. However, without limitation, the NPU controller 130 may also be configured to analyze the neural network model to extract the quantized information. Thus, the output data X-bit may be converted to a quantized bit width to correspond to the quantized data size. The output data X-bit of the bit quantization unit 114 may be stored in the NPU internal memory 120 in the quantized bit width.

The plurality of processing elements 110 of the neural processing unit 100 according to an example of the present disclosure may include a multiplier 111, an adder 112, and an accumulator 113. A bit quantization unit 114 may be selected depending on whether quantization is to be applied. In other examples, the bit quantization unit may be configured to be included in the SFU 150.

FIG. 4B is a schematic diagram illustrating an SFU 150, according to one embodiment. Referring to FIG. 4B, the SFU 150 may include multiple functional units or circuits. Each functional unit or circuit may be selectively activated. That is, each functional unit or circuit may be selectively turned on or off. The SFU 150 may include a variety of circuitry units necessary for performing neural network inference operations.

For example, the circuits of the SFU 150 may perform one or more of: skip-connection operations, apply activation functions, pooling operations, dequantization operations, quantization operations, non-maximum suppression (NMS) operations, batch-normalization operations, interpolation operations, concatenation operations, and bias operations. In addition, since certain functional unit need to be processed with floating-point parameters, conversion of floating-point parameters to integer parameters may be selectively performed in the SFU 150. Each functional unit may comprise a respective circuit. The functional unit for the quantization operation and the functional unit for the de-quantization operation may be combined into a single circuit.

The functional circuits of the SFU 150 may be selectively turned on and/or off based on the data locality information of the neural network model. The data locality information of the neural network model may include control information related to turning on or off a corresponding functional unit when computation for a particular layer is performed. Selectively turning off some functional units of the SFU 150 may reduce power consumption of the neural processing unit 100. Alternatively, power gating may be utilized to turn off some functional circuits. Alternatively, clock gating may be performed to turn off some functional circuits.

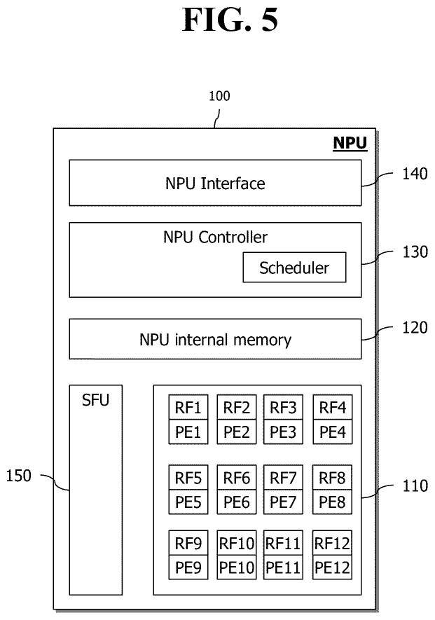

FIG. 5 is neural processing unit 100, according to another embodiment. Since the neural processing unit 100 shown in FIG. 5 is substantially the same as the processing unit 100 exemplified in FIG. 3, with the exception of the plurality of processing elements 110, redundant description may be omitted herein for ease of explanation only.

The plurality of processing elements 110 exemplarily shown in FIG. 5 may further include, in addition to the plurality of processing elements PE1 to PE12, respective register files RF1 to RF12 corresponding to each of the processing elements PE1 to PE12. The plurality of processing elements PE1 to PE12 and the plurality of register files RF1 to RF12 shown in FIG. 5 are illustrative only, and the number of the plurality of processing elements PE1 to PE12 and the plurality of register files RF1 to RF12 is not limited.

The number of the plurality of processing elements PE1 to PE12 and the number of the plurality of register files RF1 to RF12 may determine the size or number of the plurality of processing elements 110. The size of the plurality of processing elements 110 and the plurality of register files RF1 to RF12 may be implemented in the form of an N×M matrix, where N and M are integers greater than zero.

The array size of the plurality of processing elements 110 may be designed in consideration of the characteristics of the neural network model in which the neural processing unit 100 operates. In particular, the memory size of the register file may be determined by considering the data size of the neural network model to be operated, the required operation speed, the required power consumption, and the like.

The register files RF1 to RF12 of the neural processing unit 100 are static memory units directly connected to the processing elements PE1 to PE12. The register files RF1 to RF12 may comprise, for example, flip-flops and/or latches. The register files RF1 to RF12 may be configured to store MAC operation values of the corresponding processing elements PE1 to PE12. The register files RF1 to RF12 may be configured to provide or receive weight data and/or node data with the NPU internal memory 120.

The register files RF1 to RF12 may also be configured to function as temporary memory for the accumulator during MAC operations.

### Operations of Neural Network Optimization Device

In order to accelerate AI computation, the neural processing unit 100 specialized for AI computation may have various hardware optimized circuit configurations. On the other hand, a conventional neural network model is a neural network model that is trained without considering the hardware characteristics of the neural processing unit 100. That is, the conventional neural network model is trained without considering the hardware limitations of the neural processing unit 100. Therefore, when processing a conventional neural network model, the processing performance on the corresponding neural processing unit 100 may not be optimized. For example, processing performance degradation may be due to inefficient memory management and processing of large computational volumes of the neural network model. Therefore, the conventional neural processing unit 100 for processing a conventional neural network model may involve high power consumption and/or have a low computational processing speed problem.

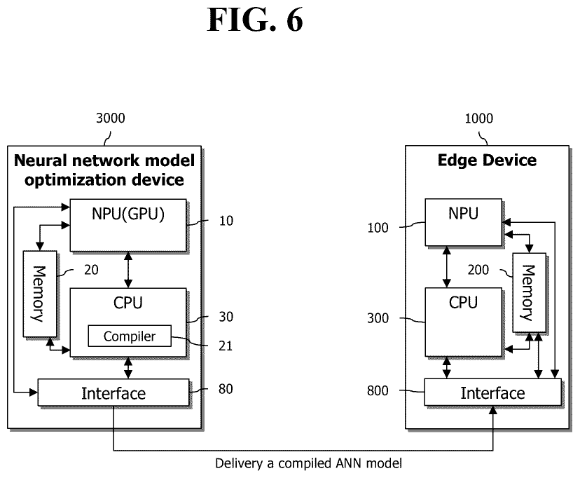

FIG. 6 is an example diagram illustrating a neural network model optimization device 3000 and an edge device 1000, according to an example of the present disclosure. As shown, the neural network model optimization device 3000 is a separate, external system configured to optimize a neural network model used by the neural processing unit 100 in the edge device 1000 according to an example of the present disclosure. An edge device according to examples of the present disclosure may also be referred to as an on-device. Thus, the neural network model optimization device 3000 may also be referred to as a dedicated neural network model emulator or neural network model simulator of the neural processing unit 100 in the edge device 1000.

The edge device 1000 may include the neural processing unit 100, the memory 200, the CPU 300, and the interface 800.

The neural network model optimization device 3000 may include a neural processing unit (NPU) or graphics processing unit (GPU) 10, memory 20, CPU 30, and interface 80.

The neural network model optimization device 3000 may be in communication with the neural processing unit 100 in the edge device 1000. To this end, the interface 80 of the neural network model optimization device 3000 may establish a link or session with the interface 800 of the edge device 1000. The interface may be an interface based on IEEE 802.3 for wired LAN or IEEE 802.11 for wireless LAN. Alternatively, the interface may be a peripheral component interconnect express (PCIe) based interface or a personal computer memory card international association (PCMCIA) based interface. Alternatively, the interface may be a universal serial bus (USB) based interface. However, the examples of the present disclosure are not limited to any particular interface and various interfaces may be employed.

The neural network model optimization device 3000 may optimize a neural network model to be driven by the neural processing unit 100 in the edge device 1000. To this end, the neural network model optimization device 3000 may receive the neural network model from the edge device 1000. Alternatively, the neural network model optimization device 3000 may be configured to separately receive a neural network model from an external device.

When the neural network model optimization device 3000 receives the neural network model to be executed by the neural processing unit 100 in the edge device 1000, the model may be stored in the memory 20 in the neural network model optimization device 3000.

If the provided neural network model is generated by a particular machine learning framework software, the neural network model may not be immediately operable on the edge device 1000. Therefore, the compiler 21 of the neural network model optimization device 3000 may be configured to compile the neural network model to generate machine code that is operable on the neural processing unit 100 of the edge device 1000.

The CPU 30 in the neural network model optimization device 3000 may control the compiler 21. Here, the compiler 21 may be a semiconductor circuit, or may be software stored in the memory 20 and executed by the CPU 30. The compiler 21 may be a software or a group of software that work together. For example, certain submodules of the compiler 21 may be included in the first software, while other submodules may be included in the second software.

The compiler 21 may compile a neural network model stored in the memory 20, optimized for the neural processing unit 100 of the edge device 1000.

For optimizing the neural network model, the neural network model optimization device 3000 may be configured to analyze the neural network model to be optimized. Specifically, the compiler 21 of the neural network model optimization device 3000 may analyze the neural network model.

The neural network model optimization device 3000 may analyze parameter information of each layer of the neural network model. The neural network model optimization device 3000 may analyze the size of the weight parameters and feature map parameters of each layer. The neural network model optimization device 3000 may analyze the connectivity between the respective layers. The neural network model optimization device 3000 may analyze the magnitude of the input parameters and output parameters of each layer. Here, a parameter of the multidimensional matrix may be referred to as a tensor. The neural network model optimization device 3000 may analyze the function modules applied to each layer. The neural network model optimization device 3000 may analyze the bifurcation points of a particular layer. The neural network model optimization device 3000 may analyze the merge points of the particular layers.

Further, the neural network model optimization device 3000 may analyze non-graph-based function modules applied to each layer. Further, the neural network model optimization device 3000 may be configured to convert the non-graph-based function modules into graph-based modules.

For example, the non-graph-based functions included in each layer may include, for example, add function, subtract function, multiply function, divide function, convolution function, matrix multiplication function, slice function, concatenation function, tensor view function, reshape function, transpose function, softmax function, permute function, chunk function, split function, clamp function, flatten function, tensor mean function, and sum function. Additionally, the above functions may be provided as non-graph-based functions in certain machine learning framework software. Here, the neural network model optimization device 3000 may be configured to explore the non-graph-based functions.

The slice function may extract a portion of the tensor. The slice function may be used to select a particular element or range in a particular dimension of the tensor.

The concatenation function can combine two or more tensors along a specified axis. The concatenation function is used to connect tensors to create a larger tensor, and can often be utilized to combine data along batch or feature dimensions.

The tensor view function can reshape a tensor without changing the data. The tensor view function can change the appearance of a tensor by providing a different representation of the same data, making it compatible with different operations.

The reshape function can change the shape of a tensor. The reshape function is used to modify the dimensions of a tensor and can change the existing data if the new shape is incompatible with the existing data.

The transpose function can swap the dimensions of a tensor. The transpose function can be used to swap the dimensions of a tensor, primarily for operations such as matrix multiplication.

The softmax function can transform a vector of real numbers into a probability distribution. The softmax function is often used in multi-class classification problems to obtain class probabilities from the output layer of a neural network.

The permute function can change the dimensions of a tensor in a specified order. The permute function is similar to the transpose function, but the dimensions can be reordered arbitrarily.

The chunk function can break the tensor into a specific number of chunks along the specified dimensions. The chunk function can be used to divide a tensor into chunks of equal size or a specified size.

The split function can split a tensor into multiple tensors along a specified dimension. Unlike chunk, the split function can provide more flexibility to specify the size of the resulting chunks.

The clamp function can clip the values of a tensor to within a specified range. The clamp function can be useful for constraining the value of a tensor to a specific range in optimization scenarios.

The flatten function can convert a multidimensional tensor to a one-dimensional tensor. The flatten function is often used in neural networks to transition from a convolutional layer to a fully connected layer.

The tensor mean function can compute the average of a tensor along a specified dimension. The tensor mean function is often used for normalization or data summarization and can be useful for obtaining the average value of a tensor along a particular axis.

The neural network model optimization device 3000 may be configured to further receive data about the hardware of the neural processing unit 100 within the edge device 1000. Data about the hardware of the neural processing unit 100 may include, for example, information about the internal memory 120 within the neural processing unit 100 (e.g., size of the internal memory, bitwidth of read/write operations to the internal memory, information about the type/structure/speed of the internal memory), information about whether integer or floating-point operations are supported, and if so, how many bits of integer can be operated on (e.g., int8, and the like), information about whether it can operate on floating-point numbers, and if so, how many bits of floating-point numbers can be supported, information about the frequency of operation, information about the number of PEs, information about the type of special function unit, and the like. However, the present disclosure is not limited thereto.

The memory 20 in the neural network model optimization device 3000 may store the software, if the compiler 21 is implemented as software as described above. The CPU 30 of the neural network model optimization device 3000 may execute the software.

The memory 20 in the neural network model optimization device 3000 may store a neural network model to be driven by the neural processing unit 100 in the edge device 1000. Further, when optimization of the neural network model is completed in the neural network model optimization device 3000, the memory 20 in the neural network model optimization device 3000 may store the optimized neural network model.

It is possible for at least some of the neural network model optimization device according to examples of the present disclosure to be configured for inclusion in an edge device according to examples of the present disclosure. For example, the compiler of the neural network model optimization device according to examples of the present disclosure may be implemented as a universal compiler embedded in the edge device according to examples of the present disclosure.

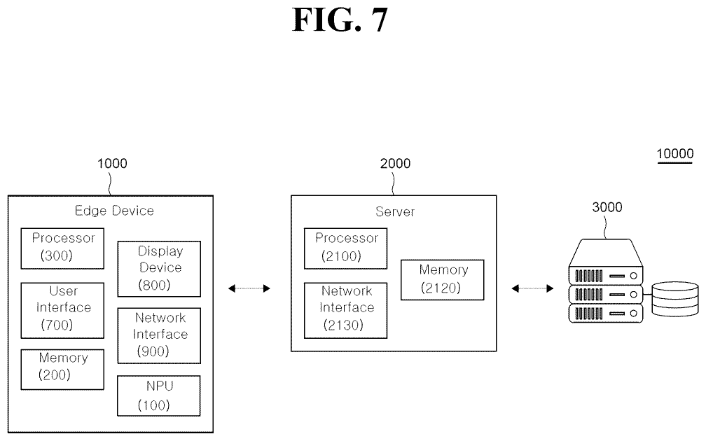

FIG. 7 is a block diagram of an neural network model performance evaluation system according to another example of the present disclosure.

Referring to FIG. 7, a neural network model performance evaluation system 10000 according to another example of the present disclosure may include an edge device 1000, a neural network model optimization device 3000, and a server 2000.

The neural network model performance evaluation system 10000 according to another example of the present disclosure in FIG. 7 is an example configured to process a specific neural network model in the neural network model optimization device 3000 and provide a performance evaluation result of the neural network model optimization device 3000 to a user.

That is, according to another example of the present disclosure, the neural network model optimization device 3000 according to one example of the present disclosure may be provided online.

The edge device 1000 may be a device carried by a user who wishes to obtain performance evaluation result information of the neural network model optimization device 3000 to process the neural network model.

The edge device 1000 may be a device carried by a user who wishes to obtain information regarding performance evaluation results of the neural network model optimization device 3000 for processing a neural network model. The edge device 1000 may include a smartphone, tablet PC, PC, laptop, or the like that can be connected to the server 2000 and provide a user interface for viewing information related to the neural network model. In this example, the edge device 1000 may be a user device.

The edge device 1000 may also include a neural processing unit 100, and may receive an optimized neural network model from the neural network model optimization device 3000 for use in the user's neural processing unit 100.

The edge device 1000 may connect to the server 2000 via a web service, via an FTP server, via a cloud server, via an application on the edge device 1000, or via an application on the edge device 1000. However, the methods by which the edge device 1000 connects to the server 2000 are not limited to these, and may utilize a variety of known communication technologies.

The user may utilize various communication technologies to transmit information about the neural network model to the server 2000. Specifically, the user may upload at least one specific neural network model and at least one specific evaluation dataset of the neural network model to the server 2000 via the edge device 1000 for optimization of a neural processing unit that the user owns or for performance evaluation of another neural processing unit that the user is interested in purchasing.

The specific evaluation dataset described above may refer to a dataset that is input to the neural network model optimization unit 3000 for performance evaluation of the neural network model optimization unit 3000.

The edge device 1000 may receive a performance evaluation result of the neural network model optimization device 3000 for the neural network model from the neural network model optimization device 3000, and may output the performance evaluation result of the neural network model optimization device 3000.

For example, the edge device 1000 can be any type of terminal that can upload information to the server 2000 about a neural network model to be evaluated by the neural network model performance evaluation system 10000.

For example, the edge device 1000 may be any type of terminal capable of uploading an evaluation dataset for evaluating a neural network model to the neural network model performance evaluation system 10000.

For example, the edge device 1000 may be any type of terminal capable of uploading a training dataset for retraining the neural network model to the neural network model performance evaluation system 10000.

In other words, the edge device 1000 may be referred to as a data transmission unit for evaluating the performance of the neural network model or a receiving unit for evaluating the performance of the neural network model.

To this end, the edge device 1000 may include a processor 300, a display device 800, a user interface 700, a network interface 900, and a memory 200. The display device 800 can display options for selecting one or more NPUs. The display device 800 may also display options for compiling a neural network model. The memory 200 can store executable software modules for the processor 300 to access the server 2000, and can also store a set of neural network model and performance evaluation data for transmission via the server 2000 to the neural network model optimization device 3000. The user interface 700 may include a keyboard and mouse, and may provide user input associated with the user selecting one or more neural processing units to process the neural network model and selecting compilation options associated with compiling the neural network model. The network interface 900 is a hardware component (e.g., a network interface card) that enables the edge device 1000 to communicate with the server 2000 over a network.

The neural network model optimization device 3000 may include a neural processing unit for processing a neural network model received from the edge device 1000 via the server 2000. The neural network model optimization device 3000 may also compile and evaluate the neural network model. The neural network model optimization device 3000 may determine the performance of the processed neural network model and may report the performance results to the edge device 1000 via the server 2000.

The neural network model optimization device 3000 may include a system comprising a general-purpose computer, a laptop, a cloud computer, a cloud server, or the like that performs various programs for determining information about the neural processing unit. The neural network model optimization device 3000 may obtain from the server 2000 at least one specific neural network model for evaluating the performance of the neural processing unit and at least one specific evaluation dataset input to the neural network model, compile and process the neural network model, and provide performance evaluation results.

The server 2000 may be a computing device that communicates with the edge device 1000 to manage access to the neural network model optimization device 3000. The server 2000 may include a processor 2100, a network interface 2130, and memory 2120. The network interface 2130 may allow the server 2000 to communicate with the edge device 1000 and the neural network model optimization device 3000 over a network. The memory 2120 may store instructions executable by processor 2100 to perform one or more of the following tasks: (i) manage accounts for a user, (ii) authenticate and allow users when they perform access to evaluate one or more neural processing units (iii) receive the neural network model, evaluation datasets, the user's selection on NPUs to be evaluated, and the user's selection on compilation choices, (iv) encrypt and store data received from the user, (v) send the neural network model and user's selection information to the neural network model processing device 2000a via a network, and (vi) forward a performance report on the selected NPUs and recommendation on the NPUs to the edge device 1000 via a network. The server 2000 may perform various other services.

For further clarification, user-developed neural network models, training datasets, evaluation datasets, and the like constitute intellectual property of the user and require strict security. Hereinafter, the user-developed neural network model, training dataset, evaluation dataset, and the like may be referred to as user data. Therefore, to secure the user data uploaded to the performance evaluation system 10000, the performance evaluation system 10000 may be configured to perform user account login, data encryption, differential privacy, and data masking to protect the data itself, as well as access control and auditing of the model, access control, and audit logging.

Data encryption protects the confidentiality of data by encrypting user data. Differential Privacy uses statistical techniques to desensitize user data to data, including personal information. Data Masking protects user data by masking parts of it to hide sensitive information.

In addition, access control may limit which accounts can access user data, audit logging may record which accounts have accessed user data, and audit logging may maintain logs of system and user data access to track who accessed the model and when, and detect unusual activity.

In addition, the uploading of training and/or evaluation datasets may further involve signing a separate user data protection agreement. Thus, the user's neural network model, training dataset, and/or evaluation dataset may be protected.

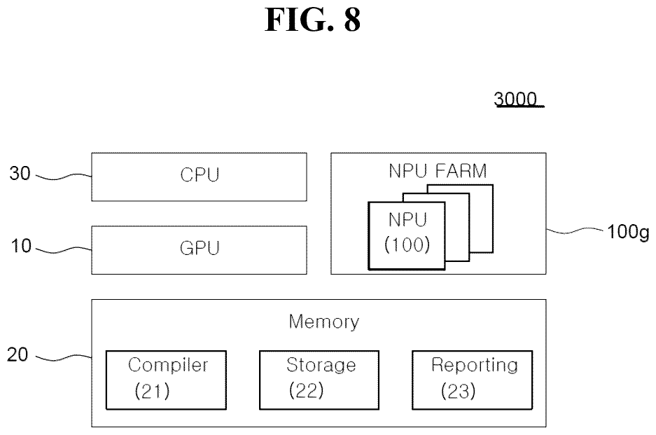

Hereinafter, with reference to FIG. 8, a neural network model optimization device 3000 will be described.

FIG. 8 is a block diagram of the neural network model optimization apparatus 3000, according to one embodiment. Referring to FIG. 8, the neural network model optimization device 3000 may include a central processing unit (CPU) 30, an NPU farm 100 comprising a plurality of neural processing units (NPUs), a graphic processing unit (GPU) 10, and a memory 20, each configuration communicating with each other via one or more communication buses or signal lines. The neural network model optimization device 3000 may be operated by a particular operating system (OS). For example, the OS may be Microsoft Windows, MacOS, Linux (e.g., Ubuntu, Fedora, Debian, CentOS, Arch Linux), Unix, iOS, Android, or the like.

The CPU 30 may include one or more operating processors for executing instructions stored in the memory 20. The memory 20 may store various software modules, including, but not limited to, a compiler 21, a storage module 22, and a reporting program 23.

Additionally, the memory 20 may include a volatile or non-volatile recording medium that can store various data, instructions, and information.

For example, the memory 20 may include a storage medium of at least one of the following types: flash memory type, hard disk type, multimedia card micro type, card type memory (e.g., SD or XD memory, and the like), RAM, SRAM, ROM, EEPROM, PROM, network storage, cloud, and blockchain database.

The CPU 30 or the GPU 10 in the neural network model optimization device 3000 may load and execute the compiler 21 stored in the memory 20. The compiler 21 may be a semiconductor circuit, or it may be software stored in the memory 20 and executed by the CPU 30.

The compiler 21 may translate a particular neural network model into machine code that can be executed by the plurality of neural processing units 100. That is, the compiler 21 may generate machine code that can be executed by the plurality of neural processing units 100, each having a different configuration and/or characteristics. Accordingly, the compiler 21 may generate machine code to be executed on a selected neural processing unit 100 of the plurality of neural processing units 100. The machine code may also be referred to as binary code.

The compiler 21 may generate machine code for a neural network model to evaluate the performance of the at least one neural processing unit 100 selected for performance evaluation.

The compiler 21 may be configured to provide various compilation options. The compilation options may be provided as a UI on a screen of the edge device 1000 for selection of the various compilation options. The compiler 21 may set the plurality of compilation options differently for each of the neural processing units selected for performance evaluation to generate machine code for the optimized neural network model.

Since the plurality of compilation options may vary according to the types of the plurality of neural processing units 100, the compiled machine code of the same neural network model may vary according to the types of the plurality of neural processing units 100 (e.g., a respective machine code may be generated for each selected compilation option).

The storage module 22 may store various data used by the neural network model optimization device 3000. That is, the storage module 22 may store at least one among the following: the compiled neural network model in the form of machine code, one or more training data sets, one or more evaluation data sets, performance evaluation results, and output data from the plurality of neural processing units 100.

The reporting program 23 may process the compiled neural network model to report the above performance evaluation results. That is, the reporting program 23 first determines whether the compiled neural network model is capable of being processed by the plurality of neural processing units 100.

If the compiled neural network model is not processable by the plurality of neural processing units 100, the reporting program 23 may report a particular layer of the plurality of layers of the neural network model that is not processable by the plurality of neural processing units 100, or a particular operation that is not processable by the plurality of neural processing units 100.

If the compiled neural network model is executable by a particular neural processing unit of the plurality of neural processing units 100, the reporting program 23 may report the processing performance of the plurality of neural processing units 100.

The performance may be indicated by performance parameters such as a temperature profile, power consumption (Watt), trillion operations per second per watt (TOPS/W), frames per second (FPS), tokens per second (TPS), inference per second (IPS), and inference accuracy. Temperature profile refers to the temperature change data of a NPU measured over time when the NPU is operating.

Power consumption refers to power data measured when the NPU is operating. Because power consumption depends on the computational load of the user-developed neural network model, the user's neural network model may be provided and deployed for accurate power measurement.

Trillion operations per second per watt (TOPS/W) is a metric that measures the efficiency of AI accelerator, meaning the number of operations that can be performed for one second per watt.

TOPS/W is an indicator of the energy efficiency of the plurality of NPUs 100, as it represents how many operations the hardware can perform per unit of power consumed.

Inference Per Second (IPS) is an indicator of the number of inference operations that the plurality of NPUs 100 can perform in one second, thus indicating the computational processing speed of the plurality of NPUs 100. IPS may also be referred to as frame per second (FPS).

Tokens Per Second (TPS) is an indicator of the number of token generation that the plurality of NPUs 100 can perform in one second, thus indicating the computational processing speed of the plurality of NPUs 100.

Accuracy refers to the inference accuracy of the plurality of NPUs 100, as an indicator of the percentage of samples correctly predicted out of the total. As further explained, the accuracy of the plurality of NPUs 100 and the inference accuracy of the graphics processing unit 10 may differ. This is because the parameters of the neural network model inferred by the graphics processing unit 10 may be in a form of floating-point, while the parameters of the neural network model inferred by the plurality of NPUs 100 may be in a form of integers. Further, various optimization algorithms may be optionally applied. Thus, the parameters of the neural network models inferred by the plurality of NPUs 100 may have differences in values calculated by various operations, and thus may have different inference accuracies from the neural network models inferred by the graphics processing unit 230. The difference in inference accuracy may depend on the structure and parameter size characteristics of the neural network model, and in particular, the shorter the length of the bitwidth of the quantized parameter, the greater the degradation in inference accuracy due to excessive quantization. For example, the quantized bitwidth can be from 2-bit to 16-bit. The degradation of inference accuracy due to excessive pruning also tends to be larger.

The plurality of neural processing units 100 may be in the form of an NPU farm 100g comprising different families of NPUs of different performance and price that are sold by a particular company. The NPU farm 100g may be provided online to perform performance evaluation of a user-developed neural network model. The NPU farm may be provided in the form of cloud NPUs.

The plurality of neural processing units 100 may receive an evaluation dataset and input it into a compiled neural network model to perform a performance evaluation.

The plurality of neural processing units 100 may include various types of neural processing units.

More specifically, the plurality of neural processing units 100 may be categorized based on computational power.

For example, a first NPU may be a NPU for a smart CCTV. The first NPU may have the characteristics of ultra-low power, low-level inference processing power (e.g., 5 TOPS of processing power), very small semiconductor package size, and very low price. Due to performance limitations, the first NPU may not support certain neural network models that include certain operations and require high memory bandwidth. For example, the first NPU may have a model name “DX-V1” and may compute neural network models such as ResNet, Mobilenet v1/v2, SSD, YOLOv5, YOLOv7, and the like.

For example, the second NPU may be a NPU for image recognition, object detection, and object tracking of a robot. The second NPU may have the characteristics of low power, moderate inference processing power (e.g., 16 TOPS of processing power), small semiconductor package size, and low price. The second NPU may not support certain neural network models that require high memory bandwidth. For example, the second NPU may have a model name “DX-V2” and may compute neural network models such as ResNet, Mobilenet v1/v2, SSD, YOLOv5, YOLOv7, and the like.

For example, the third NPU may be a NPU for image recognition, object detection, object tracking, and generative AI services for autonomous vehicles. The third NPU may have low power, high level inference processing power (e.g., 25 TOPS of processing power), medium semiconductor package size, and medium price. For example, the third NPU may have a model name “DX-M1” that may compute neural network models such as ResNet, MobileNet v1/v2/v3, SSD, EfficientNet, EfficientDet, YOLOv5, YOLOv7, YOLOv8, DeepLabv3, PIDNet, VIT, Generative adversarial network, Stable diffusion, and the like. The fourth NPU may be a NPU for CCTV control rooms, control centers, large language models, and generative AI services.

For example, the fourth NPU may have low power, high level inference processing power (e.g., 400 TOPS of processing power), large semiconductor package size, and high price characteristics. For example, the fourth NPU may have a model name “DX-H1”, and may compute neural network models such as ResNet, Mobilenet v1/v2, SSD, YOLOv5, YOLOv7, YOLOv8, DeepLabv3, PIDNet, VIT, Transformer, Generative adversarial network, Stable diffusion, and large LLM. In other words, each NPU can have different computational processing power, different semiconductor chip die sizes, different power consumption characteristics, and the like. However, the types of the plurality of NPUs 100 are not limited thereto and may be categorized by various classification criteria.

That is, each of the neural processing units may have different computational processing power, different semiconductor chip sizes, different power consumption characteristics, and the like.

However, the types of the plurality of neural processing units 100 are not limited to this, and can be categorized by various classification criteria.

The GPU 10 is hardware that performs complex computational tasks in parallel. The GPUs are widely used in graphics and image processing but have expanded their uses to processing various machine learning operations. Although GPU 10 is illustrated as a single device, it may be embodied as a plurality of graphics processing units connected by a cloud GPU, NVLink, NVSwitch, or the like.

The graphics processing unit 10 may include a plurality of cores that process multiple tasks in parallel. Thus, the graphics processing unit 10 can perform large-scale data processing tasks such as scientific computation and deep learning.

Specifically, the graphics processing unit 10 can be used to train deep learning and machine learning models on large datasets. Deep learning models have a large number of parameters, making training time-consuming, and the graphics processing unit 10 can process these computations in parallel to speed up training. When a user selects a particular neural processing unit from the plurality of neural processing units 100, and performs retraining of the neural network model through various compilation options, the graphics processing unit 10 may select a useful graphics processing unit, and the selected graphics processing unit may perform retraining of the neural network model according to each compilation option.

The plurality of neural processing units 100 and graphics processing unit 10 may be implemented in the form of an integrated chip (IC), such as a system on chip (SoC) that integrates various computing devices, or a printed circuit board on which the integrated chip is mounted.

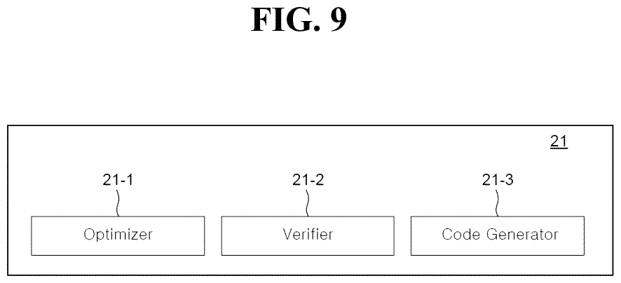

FIG. 9 is a block diagram illustrating a configuration of the compiler shown in FIG. 8. Referring to FIG. 9, the compiler 21 of the neural network model optimization device may compile a neural network model into machine code based on a plurality of compilation options.

The compiler 21 of the neural network model optimizer may include an optimizer 21-1, a verifier 21-2, and a code generator 21-3.

The compiler 21 may be provided with hardware data of a neural processing unit selected from the plurality of neural processing units 100. The hardware data of the neural processing unit may include a memory size of the NPU internal memory, a hierarchical structure of the NPU internal memory, information on the number of processing elements, information on the special function calculation circuit, and the like. The compiler 21 may determine a processing order for each layer based on the structural data of the neural processing unit and the graph information of the neural network model to be compiled.

The optimizer 21-1 may perform the task of modifying the neural network model represented by a directed acyclic graph (DAG) to increase one or more of efficiency, accuracy and speed. The user may select at least one of various optimization options provided by the optimizer 21-1 online via the edge device 1000.

For example, the optimizer 21-1 may provide an option to convert to parameters of a particular bitwidth to parameters of another bitwidth. The specific bitwidth may be between 2-bit and 16-bit. For example, the optimizer 21-1 may convert the neural network model based on floating-point parameters to a neural network model based on integer parameters when the one or more selected NPUs 100 are designed to process integer parameters. The optimizer 21-1 may also convert a neural network model based on nonlinear trigonometric operations to an neural network model based on piecewise linear function approximation when the one or more selected NPUs 100 are designed to process the piecewise linear function approximation operations. The optimizer 21-1 may also apply various optimization algorithms to reduce the size of parameters such as weights, feature maps, and the like of the neural network model. For example, the optimizer 21-1 can improve the accuracy degradation problem of an optimized neural network model by using various retraining algorithms.

The verification module 21-2 may perform validation to determine whether the user's neural network model is operable on the one or more selected NPUs 100. The verification module 21-2 determines whether the neural network model is executable by analyzing the structure of the modified neural network model and determining whether the operations at each layer are supported by the hardware of the one or more selected NPUs 100. If the operations are not executable, a separate error report file can be generated and reported to the user.

The code generator 21-3 may optimize the neural network model determined to be operable by the verifier 21-2 through the optimizer 21-1, and may generate machine code executable on selected neural processing units of the plurality of neural processing units 100, respectively. The generated machine code may be provided to a corresponding neural processing unit to perform a performance evaluation of the plurality of neural processing units 100.

For example, a first machine code corresponding to a first neural network model may be generated for a first neural processing unit of the plurality of neural processing units 100. A second machine code corresponding to the first neural network model may be generated for a second neural processing unit of the plurality of neural processing units 100. A third machine code corresponding to the first neural network model may be generated for a third neural processing unit of the plurality of neural processing units 100. A fourth machine code corresponding to the first neural network model may be generated for a fourth neural processing unit of the plurality of neural processing units 100.

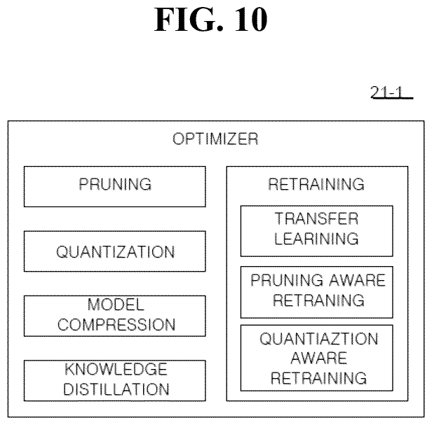

FIG. 10 is a block diagram illustrating the configuration of the optimizer shown in FIG. 9.

The optimizer 21-1 may optimize the neural network model based on a plurality of compilation options.

More specifically, the optimizer 21-1 may set the compilation options based on hardware information of the neural processing unit 100.

Further, the optimizer 21-1 may set the plurality of compilation options in consideration of characteristics of parameters of the neural network model (e.g., size of weights, size of feature map, and the like) and characteristics of inference accuracy degradation.

The plurality of compilation options set using the optimizer 21-1 may be at least one of a quantization option, a pruning option, a retraining option, a model compression option, an AI based model optimization option, and a knowledge distillation option.

Without limitation, the optimizer 21-1 can apply an artificial intelligence-based optimization to the neural network model. An artificial intelligence-based optimization algorithm may be a method of generating a reduced size of the neural network model by applying various algorithms from the compilation options. This may include exploring the structure of the neural network model using an AI-based reinforcement learning method or a method that is not based on a reduction method such as a quantization algorithm, a pruning algorithm, a retraining algorithm, a model compression algorithm, and a model compression algorithm, but rather a method in which an artificial intelligence integrated in the optimizer 21-1 performs a reduction process by itself to obtain an improved reduction result.

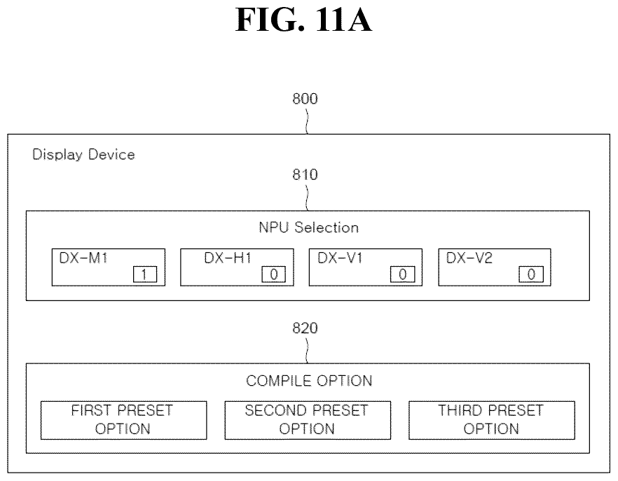

FIG. 11A is a block diagram illustrating a plurality of neural processing units of a neural network model processing device and an interface for selecting compilation options, according to one example.

The user interface 700 may be displayed on a display device 800 of the edge device 1000 after a user accesses the server 2000 using the edge device 1000.

The display device 800 displays two sections: an NPU selection section 810 and a compile options section 820. A user can select one or more NPUs in the NPU selection section 810 to run simulations for the neural network model using one or more evaluation datasets. The NPU selection section 810 displays four types of NPUs, DX-M1, DX-H1, DX-V1, and DX-V2, and allows the user to select which NPU to use in the online simulation for performance evaluation.

The compile options section 820 displays preset options to facilitate user selection of compile choices.

As shown, the compile options section 820 provides a first preset option, a second preset option, and a third preset option. However, the present disclosure is not limited to these preset options, and more preset options may be provided.

For ease of explanation, the following quantization algorithm preset may be described as an example. Each preset option may be the most effective quantization preset option from a particular perspective, but the present disclosure is not limited thereto. A user may select at least one preset option by considering the features of each preset option.

For example, the first preset option may be an option that only performs a quantization algorithm to convert 32-bit floating-point data of a trained neural network model to 8-bit integer data. However, the present disclosure is not limited to 8 bits, and may be configured to have a bitwidth between 2 bits and 16 bits, and the bitwidth may be limited to a particular bitwidth according to the hardware configuration of the selected neural processing unit. The first preset option may be referred to as post training quantization (PTQ) since the quantization algorithm is executed after training of the neural network model. The first preset option has the advantage of performing quantization quickly, typically completing within a few minutes. Therefore, it is advantageous to quickly check the results of the power consumption, computational processing speed, and the like of the neural network model provided by the user on the NPU selected by the user.

For example, a first preset option including a first quantization option may be provided to a user as an option called “DXNN Lite.” Here, the retraining step of the neural network model may not be performed because the first quantization option does not require retraining.

For example, the second preset option may perform a quantization algorithm that converts 32-bit floating-point data of the neural network model to 8-bit integer data, and then performs an algorithm for layer-wise retraining of the neural network model. However, the present disclosure is not limited to 8 bits, and may be configured to have a bitwidth between 2 bits and 16 bits, and the bitwidth may be limited to a particular bitwidth according to the hardware configuration of the selected neural processing unit.

In other words, the second preset option may be an option configured to further perform a layer-wise retraining algorithm using the neural network model that performed the first preset option as an input model. Thus, the second preset option may be a combination of the quantization algorithm and an algorithm from one of the various retraining options provided in the optimizer 21-1.

That is, in the second preset option, data corresponding to a portion of layers in the neural network model is quantized and its quantization loss function is calculated. Then, the data corresponding to another portion of the plurality of layers of the neural network model is quantized, and its quantization loss function is calculated. Such operations are repeated to enhance the quantization by reducing the quantization loss of some layers. The second preset option has the advantage that retraining can be performed in a manner that reduces the difference between the floating-point data (e.g., floating-point 32) and the integer data (e.g., integer 8) in the feature map for each layer, and hence, retraining can be performed even if there is no training dataset. The second preset option has the advantage that quantization can be performed in a reasonable amount of time, and typically completes within a few hours. Accordingly, the accuracy of the user-provided neural network model on the user-selected NPU of the plurality of NPUs 100 tend to be better than the one obtained using the first preset option.

For example, the second preset option comprising a second quantization option may be provided to a user under the service name “DXNN pro.” The second quantization option may involve a retraining step of the neural network model because it performs a layer-wise retraining of the neural network model.

For example, the third preset option may perform a quantization algorithm to convert 32-bit data representing a floating-point of the neural network model to 8-bit data representing an integer, and then perform a quantization aware training (QAT) algorithm. However, the present disclosure is not limited to 8 bits, and may be configured to have a bitwidth between 2 bits and 16 bits, and the bitwidth may be limited to a particular bitwidth according to the hardware configuration of the selected neural processing unit.

In other words, the third preset option may further perform a quantization aware retraining algorithm using the neural network model that performed the first preset option as an input model. Thus, the third preset option may be a combination of the quantization algorithm and an algorithm from one of the various retraining options provided by the optimizer 21-1.

In the third preset option, the quantization-aware retraining algorithm performs fine-tuning by quantizing the trained neural network model and then retraining it in a way that reduces the degradation of inference accuracy due to quantization. However, in order to retrain in a way that reduces the degradation of inference accuracy due to quantization, the user may provide the training dataset of the neural network model. Furthermore, an evaluation dataset may be used to suppress overfitting during retraining. Specifically, the quantization-aware retraining algorithm inputs the machine code and the training dataset of the quantized neural network model into a plurality of NPUs 100 to retrain it and compensate for the degradation of inference accuracy due to quantization errors. The third preset option has the advantage of ensuring relatively higher inference accuracy than the first and second preset options, but typically takes a few days to complete and is suitable when the accuracy has a higher priority.

The third preset option comprising a third quantization option may be provided to users under the service name “DXNN master.” The third quantization option may involve a retraining step of the neural network model because the retraining algorithm is performed based on the inference accuracy of the neural network model. For the quantization-aware retraining algorithm of the third quantization option, a training dataset and/or an evaluation dataset of the neural network model may be received from the user in the process of retraining in a direction that reduces the loss due to quantization. The training dataset is the used for quantization-aware retraining. The evaluation dataset is optional data that can be used to improve the overfitting problem during retraining.

FIG. 11B is a user interface diagram for displaying a performance report and recommendation on selection of the one or more neural processing units, according to another example of the present disclosure.

In the example of FIG. 11B, the results of performing the simulation/evaluation using two different types of NPUs are displayed. The upper left box shows the result of using DX-M1 NPU whereas the upper fight box shows the result of using DX-H1 NPU. The bottom box shows the recommended selection of NPU based on the performance parameters of the two different NPUs.

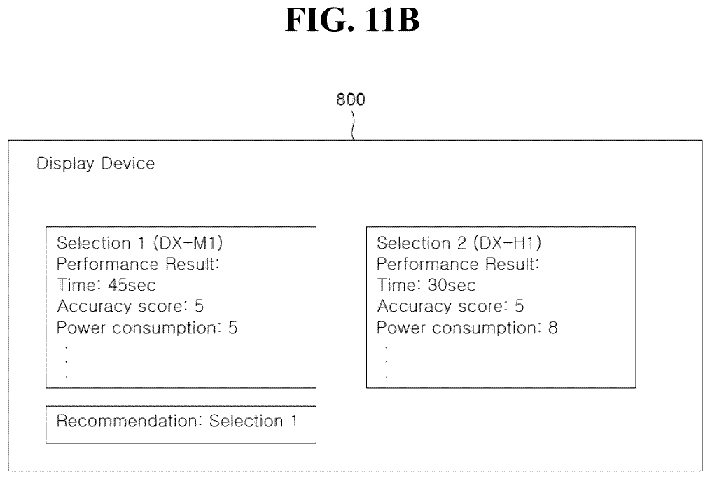

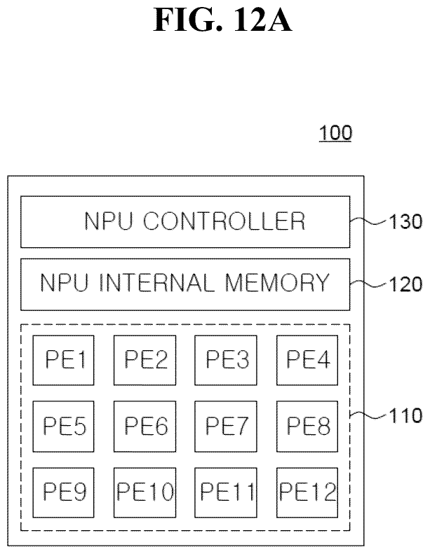

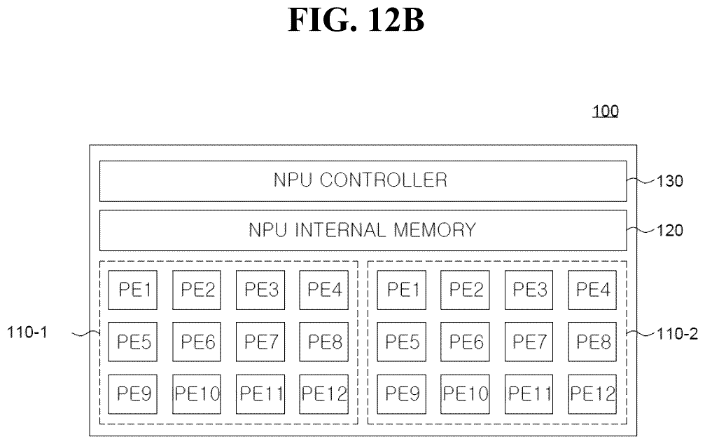

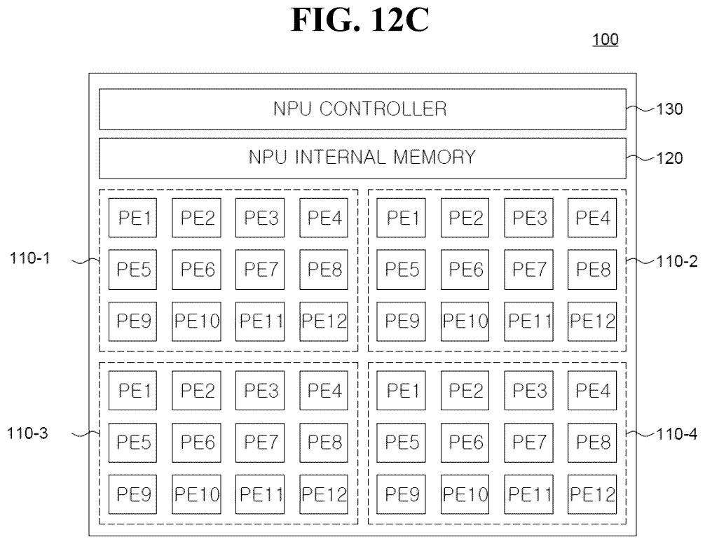

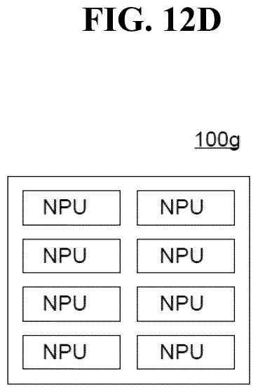

FIGS. 12A to 12D are block diagrams illustrating a configuration of one neural processing unit of a neural network model optimization device according to other examples of the present disclosure.

Specifically, FIG. 12A illustrates an internal configuration of a first NPU, FIG. 12B illustrates an internal configuration of a second NPU, FIG. 12C illustrates an internal configuration of a third NPU, and FIG. 12D illustrates an internal configuration of a fourth NPU.

The first NPU of FIG. 12A may include a processing element array 110, an NPU internal memory 200, and an NPU controller 130.

For example, the first neural processing unit 100 may be configured to include a processing element array 110, an NPU internal memory 120 configured to store a neural network model that may be inferred from the processing element array 110 or to store at least some data of the neural network model, and an NPU controller 130 configured to control the processing element array 110 and the NPU internal memory 120. Here, the neural network model may be machine code compiled with various optimization options applied.

The NPU controller 130 may be configured to control operations of the processing element array 110 and the sequence of read and write operations to the NPU internal memory 120 for inference operations of the first neural processing unit 100.

The NPU controller 130 may be configured to control the processing element array 110 and the NPU internal memory 120 by machine code. The NPU controller 130 may be configured to control the processing element array 110 and the NPU internal memory 120 for each computation step according to a computation scheduling defined by the machine code. Accordingly, the neural processing unit may sequentially process operations for each layer according to the structure of the neural network model. Here, the NPU controller 130 may obtain a memory address where the feature map and weights of the neural network model are stored or determine a memory address to be stored.

The processing element array 110 may refer to a configuration of a plurality of processing elements (PE1 to PE12) arranged in an array. Each processing element may be configured to include a multiply and accumulate (MAC) operator and/or an arithmetic logic unit (ALU) operator. However, examples according to the present disclosure are not limited thereto.

While a plurality of processing elements is exemplarily shown in FIG. 12A, it is possible for a processing element to be configured with a plurality of operators implemented as multiplier and adder trees arranged in parallel, replacing the MAC within a single processing element. In such cases, the processing element array 110 may also be referred to as at least one processing element comprising a plurality of operators.

The processing element array 110 may be configured to include a plurality of processing elements PE1 to PE12. The plurality of processing elements PE1 to PE12 shown in FIG. 12A are illustrative only for ease of description, and the number of the plurality of processing elements PE1 to PE12 is not limited. The number of the plurality of processing elements PE1 to PE12 may determine the size or number of processing element arrays 110. The size of the processing element array 110 may be implemented in the form of an N×M matrix, where N and M are integers greater than zero. The processing element array 110 may include N×M processing elements, i.e., there may be more than one processing element.

The size of the processing element array 110 can be designed taking into account the characteristics of the neural network model. In particular, the number of processing elements may be determined by considering the data size of the neural network model to be operated, the required operating speed, the required power consumption, and the like. The data size of the neural network model may be sized corresponding to the number of layers of the neural network model and the weighted data size of each layer.

Accordingly, the size of the processing element array 110 of the neural processing unit 100 according to other examples of the present disclosure is not limited. As the number of processing elements of the processing element array 110 increases, the parallel computation capability of the operational neural network model increases, but the manufacturing cost and physical size may increase.

For example, as shown in FIG. 12B, according to a second example, the neural processing unit 100 may include two processing element arrays 110-1, 110-2. Each of the two processing element arrays 110-1, 110-2 may be grouped to include a plurality of processing elements PE1 to PE12.

In another example, according to a third example, as shown in FIG. 12C, the neural processing unit 100 may include four processing element arrays 110-1, 110-2, 110-3, and 110-4. Each of the four processing element arrays 110-1, 110-2, 110-3, 110-4 may be grouped to include a plurality of processing elements PE1 to PE12.

In another example, as shown in FIG. 12D, the fourth example may include eight neural processing units according to the fourth example.

Each of the eight neural processing units 100 partitions and processes the operations of the neural network model. Accordingly, the processing speed may be further improved.

Thus, for the fourth example, a control unit may be required to assign the behavior of each of the eight neural processing units.

The characteristics of the neural processing unit 100 and the processing neural network model have been described above.

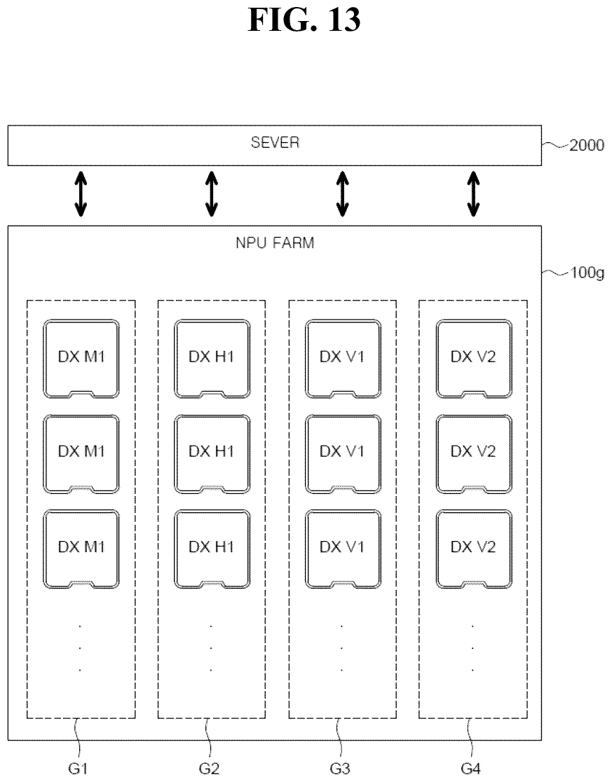

FIG. 13 is a block diagram illustrating a configuration of a plurality of neural processing units according to another example of the present disclosure.

The NPU farm 100g may include a plurality of types of neural processing units and, at least one neural processing unit of the same type may be disposed.

For example, a plurality of “DX-M1” neural processing units may be disposed to form a first group G1, a plurality of “DX-H1” neural processing units may be disposed to form a second group G2, a plurality of “DX-V1” neural processing units may be disposed to form a third group G3, and a plurality of “DX-V2” neural processing units may be disposed to form a fourth group G4. The group of the plurality of types of neural processing units may be referred to as an NPU farm 100g. The NPU farm 100g may be a cloud-type NPU system configured to respond in real time to performance evaluation requests from a plurality of users connected online.

The plurality of neural processing units 100 included in the first to fourth groups G1 to G4 may all be used for performance evaluation, or only some of them may be used for performance evaluation, according to a user's selection.

User data requiring security may be stored on the server 2000, or may be stored in the storage module 22 of the neural network model optimization device 3000.

The at least one neural processing unit 100 used for computation may communicate with the server 2000 to receive input of at least one specific neural network model for performance evaluation of the neural processing unit and at least one specific evaluation dataset that is input to the neural network model. In other words, the neural processing unit 100 may receive input of user data required for performance evaluation.

### Challenges Due to use of Diverse Compilers

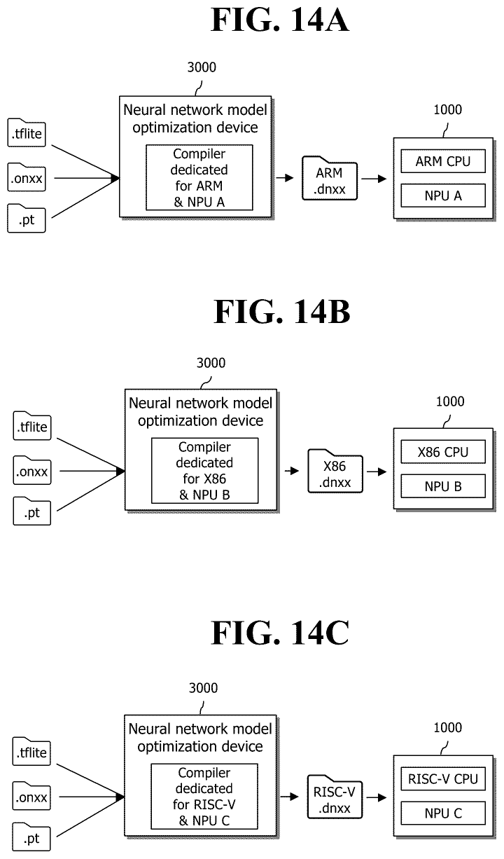

According to the foregoing, a separate neural network model optimization device 3000 is used to optimize the neural network model in consideration of the hardware characteristics of the neural processing unit 100. Furthermore, if the type of the CPU 30 of the neural network model optimization device 3000 was different from the type of the CPU 300 of the edge device 1000, the neural network model may not be compiled into machine code as desired. This will be described with reference to FIGS. 14A to 14C.

FIGS. 14A through 14C are diagrams illustrating reasons for providing a dedicated compiler, according to one embodiment. Referring to FIGS. 14A to 14C, if a neural network model is generated via the TensorFlow or TensorFlow Lite framework, the neural network model may be delivered to the neural network model optimization device 3000 as a computer file with the extension “˜. tf” or “˜. tflite”. TensorFlow can run on multiple CPUs and GPUs on mobile environments such as Android and iOS, as well as on desktop or server systems running 64-bit Linux and macOS. TensorFlow is an open-source software library for programming data flows for a variety of AI tasks. TensorFlow is used for machine learning applications such as artificial neural networks and deep learning.

In another example, if a neural network model is created through the Open Neural Network Exchange (ONNX) framework, the neural network model can be delivered to the neural network model optimization device 3000 as a computer file with the extension “˜. onxx”. ONNX has an open ecosystem that allows AI developers to choose the right tools according to their project. ONNX provides open-source formats for AI models, both deep learning and traditional ML. ONNX enables the use of scalable computational graph models as well as built-in operators and definitions of standard data types. ONNX is widely supported and can be used in a variety of frameworks, tools, and hardware.

As another example, if a neural network model has been created via the PyTorch framework, the neural network model may be delivered to the neural network model optimization device 3000 as a computer file with the extension “˜. pt”. PyTorch is an open-source machine learning library for Python. PyTorch is based on Torch and can be used for applications such as natural language processing and has the advantage of being GPU-enabled, which makes it significantly faster.

As another example, although not shown, if a neural network model is created using the hugging face framework, the neural network model may be delivered to the neural network model optimizer device 3000 as a computer file with one of the extensions “˜. pt,” “˜.tf,” “˜. onnx,” “˜ json,” and “˜. pkl.” Hugging Face is an open-source library and platform that provides tools and resources to efficiently create and deploy transformer models. Hugging Face supports moving, transforming, and merging between various frameworks such as PyTorch, TensorFlow, and ONNX.

For example, some hugging face models and datasets can be provided in JSON ('˜.json') format, a lightweight data interchange format. JSON files are human-readable and easy to parse, making them a good choice for storing model configuration, metadata, and dataset labeling. Some hugging face models and datasets may be provided in the Python-specific serialization format pickle (‘˜. pkl’). Pickle files can be used to serialize and deserialize Python objects. Pickle can be utilized to provide serialized models and datasets, and can provide compatibility with Python-based applications.

Referring to FIG. 14A, if the edge device 1000 includes an ARM-based CPU and an NPU A (i.e., a type-A NPU), the neural network model optimization device 3000 includes a dedicated compiler for the combination of the ARM-based CPU and the NPU A. If the machine code of the neural network model was generated using an X86-based CPU or a reduced instruction set computer (RISC)-V-based CPU, rather than an ARM-based CPU, the dedicated compiler may have the capability to convert X86 or RISC-V-based instructions or functions to ARM-based instructions or functions.

Referring to FIG. 14B, if the edge device 1000 includes an X86-based CPU and an NPU B (i.e., a type-B NPU), the neural network model optimization device 3000 may include a dedicated compiler for the combination of the X86-based CPU and the NPU B. If the machine code of the neural network model was generated using an ARM-based CPU or a RISC-V-based CPU, rather than an X86-based CPU, the dedicated compiler may have the capability to convert X86 or RISC-V-based instructions or functions to X86-based instructions or functions.

Referring to FIG. 14C, if the edge device 1000 includes a RISC-V-based CPU and an NPU C (i.e., a Type-C NPU), the neural network model optimization device 3000 may include a dedicated compiler for the combination of the RISC-V-based CPU and the NPU C. If the machine code of the neural network model is generated using an ARM-based CPU or an X86-based CPU, rather than a RISC-V-based CPU, the dedicated compiler may have a function for converting an ARM-based or X86-based instruction or function to RISC-V-based instruction or function.

The NPU A (i.e., a type-A based NPU) described above may be, for example, one of the DX-M1, DX-H1, DX-V1, and DX-V2 illustrated in FIG. 13. Similarly, NPU B (i.e., a type B NPU) may be, for example, one of DX-M1, DX-H1, DX-V1, and DX-V2 illustrated in FIG. 13. Further, NPU C (i.e., a type C NPU) may be, for example, one of DX-M1, DX-H1, DX-V1, and DX-V2 illustrated in FIG. 13. For example, NPU A (i.e., a type A NPU) may be DX-M1 illustrated in FIG. 13, NPU B (i.e., a type B NPU) may be DX-H1 illustrated in FIG. 13, and NPU C (i.e., a type C NPU) may be DX-V1 illustrated in FIG. 13. As another example, NPU A (i.e., a type A NPU) may be DX-H1 illustrated in FIG. 13, NPU B (i.e., a type B NPU) may be DX-V1 illustrated in FIG. 13, and NPU C (i.e., a type C NPU) may be DX-V2 illustrated in FIG. 13. The listed examples are not intended to be limiting, and various variations are possible.

As such, to interoperate with different types of edge devices, the neural network model optimization device 3000 may have to implement and execute a dedicated compiler for each different types of edge devices (e.g., different combinations of NPU and CPU). Furthermore, if the neural network model uses 32-bit floating-point via a TensorFlow, TensorFlow Lite, ONNX, or PyTorch framework as described above, but the NPU of the edge device 1000 only supports 16-bit floating-point or only integers, the dedicated compiler would perform the conversion of the conversion of numeric formats. As such, the number of dedicated compilers are increased as diversity in the types of hardware and the frameworks for neural network models is increased.

### Example Built-In Compiler

Embodiments relate to embedding a universal compiler in the edge device to alleviate or remove the increasing number of dedicated compilers. The universal compiler embedded in the edge device may generate machine code executable on CPUs and NPUs without or with only minimal assistance from the neural network model optimization device 3000. The universal compiler can compile and convert any kinds of neural network models, any CPU architectures, and any NPU architectures into executable machine code. The universal compiler can convert neural network models generated by different CPUs, different NPUs, and different frameworks into machine code that can be executed on the CPU and NPU of the edge device. Since the universal compiler can compile the machine code itself without assistance or with only minimal assistance from the neural network model optimization device 3000, changing and deployment of the neural network model are simplified and expedited from the perspective of developers.

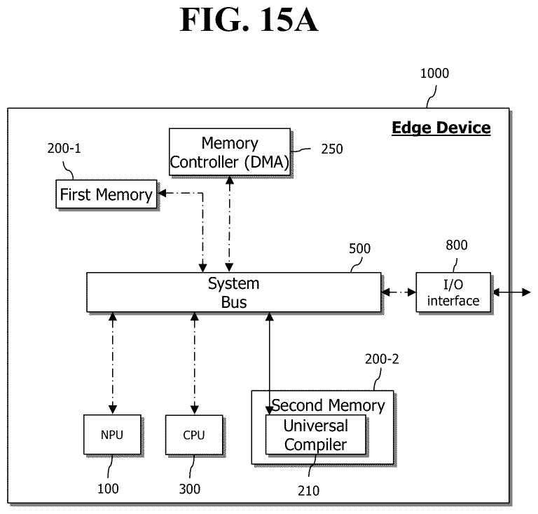

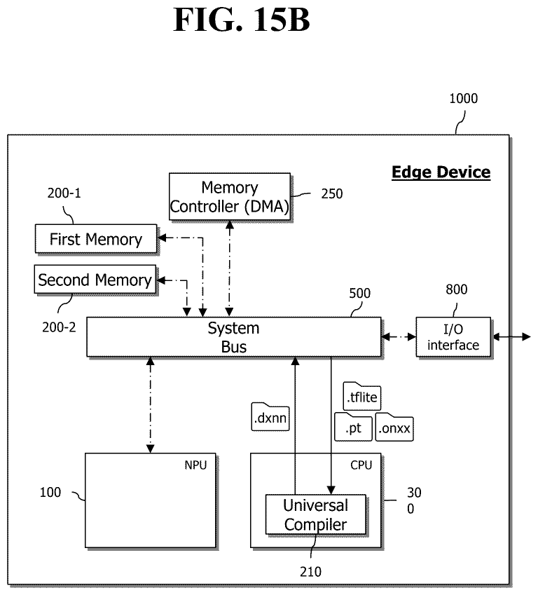

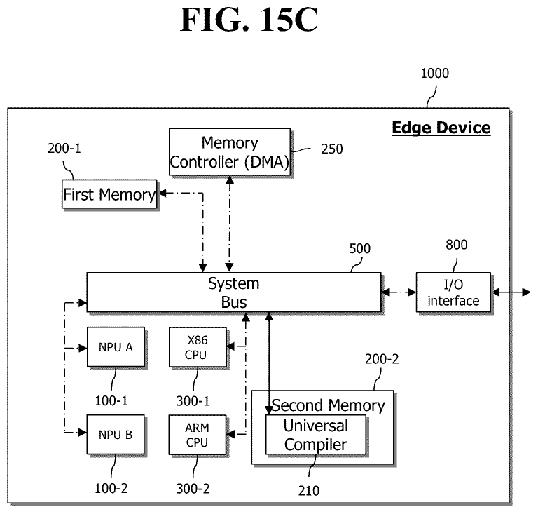

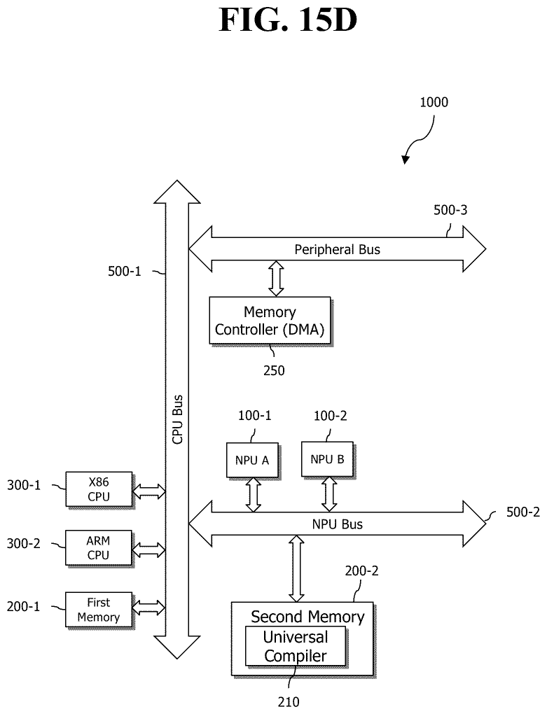

FIGS. 15A to 15C are block diagrams illustrating an edge device including a universal compiler, according to embodiments. Referring to FIGS. 15A to 15C, an edge device 1000 is an integrated circuit (IC) that includes one or more NPUs 100, 100-1, 100-2, one or more central processing units (CPU) 300, 300-1, 300-2, one or more memories 200-1, 200-2, a memory controller 250, a system bus 500, and an input output (I/O) interface 800. These components (e.g., NPUs and CPUs) may be formed on a common substrate, for example, using a standard Complementary Metal-Oxide-Semiconductor (CMOS) process, and be packaged into a single semiconductor chip or implemented as a chiplet.

The system bus 500 may be implemented by electrically conductive patterns formed on the substrate or semiconductor die. The system bus enables high-speed communication. For example, the one or more NPUs 100, 100-1, 100-2, the one or more CPUs 300, 300-1, 300-2, the universal compiler 210, the one or plurality of memories 200-1, 200-2, and the memory controller 250 may communicate with each other via the system bus 500.

As shown in FIGS. 15A to 15C, the one or more NPUs 100, 100-1, 100-2 and the one or more CPUs 300, 300-1, 300-2 may be a semiconductor implemented as an electrical/electronic circuit. In other words, the one or more NPUs 100, 100-1, 100-2, the one or more CPUs 300, 300-1, 300-2 may be a semiconductor circuit with numerous electronic elements (e.g., transistors, capacitors) connected thereto.

As shown in FIG. 15A, the universal compiler 210 may be software stored in at least one memory for execution by the one or more CPUs 300, 300-1, 300-2. The at least one memory in which the program code of the universal compiler 210 according to examples of the present disclosure is stored may be non-volatile memory. The universal compiler 210 may be a program stored in the one or more memories 200-1, 200-2, which may be executed by the CPU 300 after being read from the one or more memories 200-1, 200-2.

As shown in FIGS. 15A to 15C, the one NPU 100 or plurality of NPUs 100-1, 100-2, the one CPU 300 or plurality of CPUs 300-1, 300-2, makes a request to the memory controller 250 via the system bus 500, whereby the memory controller 250 may read and/or write data from at least one of the plurality of memories 200-1, 200-2.

As described above, the universal compiler 210 may be software. The universal compiler 210 may be in communication with the one or more NPUs 100, 100-1, 100-2 and the one or more CPUs 300, 300-1, 300-2. The universal compiler 210 may be implemented as a program executable on the one or more CPUs 300, 300-1, 300-2.

Referring to FIG. 15B, the universal compiler 210 may be embedded in the CPU 300. Alternatively, the universal compiler 210 may be implemented as a program executable on the CPU 300. In this case, the universal compiler 210 may be a program stored in the one or more memories 200-1, 200-2, which may be executed by the CPU 300 after being read from the one or more memories 200-1, 200-2.

According to one example shown in FIG. 15C, among the plurality of NPUS, the first NPU 100-1 may be an NPU of type A, and the second NPU 100-2 may be an NPU of type B. According to one example shown in FIG. 15C, among the plurality of CPUs, the first CPU 100-1 may be a CPU based on an X86 architecture, and the second CPU 100-2 may be a CPU based on an ARM architecture. According to another example, the first CPU 100-1 may be a CPU based on an ARM architecture, and the second CPU 100-2 may be a CPU based on an X86 architecture or a CPU based on a RISC-V architecture.

FIG. 15D is an illustration of an alternative form of the edge device shown in FIG. 15C.

Referring to FIG. 15D, the system bus may include a CPU bus 500-1, an NPU bus 500-2, and a Peripheral Bus 500-3.

The CPU bus 500-1 may be connected to a first CPU 300-1, a second CPU 300-2, and a first memory 200-1. The NPU bus 500-2 may be connected to a first NPU 100-1, a second NPU 100-2, and a second memory 200-2. The first memory 200-1 may store a kernel (e.g., weights) for applying to input feature maps to generate counterpart output feature maps. Also, the first memory 200-1 may further store at least one of input feature maps and output feature maps. The second memory 200-2 may store a universal compiler 210 in the form of software. The universal compiler 210 may be executed by the first CPU 300-1 or the second CPU 300-2 after being read from the second memory 200-2. In one embodiment, the first memory 200-1 and the second memory 200-2 may be combined into a single memory.

In the following, a universal compiler 210 according to examples of the present disclosure will be described in detail.

The universal compiler 210 may convert the neural network model into machine code that can be executed on different types of NPUs (i.e., NPU A, NPU B) 100-1, 100-2, respectively. In other words, the universal compiler 210 may generate machine code that can be executed on different types NPUs (i.e., NPU A, NPU B) 100-1, 100-2 having different physical/logical configurations and/or characteristics. Accordingly, the universal compiler 210 may generate machine code to be executed on a selected NPU of the heterogeneous plurality of NPUs (i.e., NPU A, NPU B) 100-1, 100-2. The machine code may also be referred to as binarized code.

For example, if the neural network model was generated via the TensorFlow or TensorFlow Lite framework, the neural network model may be delivered to the edge device 1000 via the I/O interface 800 as a computer file with the extension “˜. tf” or “˜. tflite”. Based on a combination of NPUs and CPUs, such as a combination of NPU A and an X86 CPU, a combination of NPU A and an ARM CPU, a combination of NPU A and a RISC-V CPU, a combination of NPU B and an X86 CPU, a combination of NPU B and an ARM CPU, a combination of NPU B and a RISC-V CPU, and the like, the universal compiler 210 may compile this file into another file having an extension “˜. dxnn” and transmit the converted file to the first memory 200-1 or the second memory 200-2. “˜. dxnn” is a format developed by DEEPX CO., LTD. of Seongnam si, Gyeonggi do, Republic of Korea and is generated as a result of executing a compiler developed by DEEPX CO., LTD. The compiler may convert a hardware independent graph into a file in “˜. dxnn” format that includes code executable and supported by specific hardware for which the compilation is performed.

In another example, if the neural network model was generated via the ONNX framework, the neural network model may be delivered to the edge device 1000 via the I/O interface 800 as a computer file with the extension “˜. onxx”. Based on a combination of NPUs and CPUs, such as a combination of NPU A and an X86 CPU, a combination of NPU A and an ARM CPU, a combination of NPU A and a RISC-V CPU, a combination of NPU B and an X86CPU, a combination of NPU B and an ARM CPU, a combination of NPU B and a RISC-V CPU, and the like, the universal compiler 210 may compile this file into another file having an extension “˜. dxnn” and transmit the converted file to the first memory 200-1 or the second memory 200-2.

In yet another example, if the neural network model was generated via the PyTorch framework, the neural network model may be delivered to the edge device 1000 via the I/O interface 800 as a computer file with the extension “˜. pt”. Based on a combination of NPUs and CPUs, such as a combination of NPU A and an X86 CPU, a combination of NPU A and an ARM CPU, a combination of NPU A and a RISC-V CPU, a combination of NPU B and an X86 CPU, a combination of NPU B and an ARM CPU, a combination of NPU B and a RISC-V CPU, and the like, the universal compiler 210 may compile this file into another file having an extension “˜. dxnn” and transmit the converted file to the first memory 200-1 or the second memory 200-2.

As described above, if the neural network model was generated using any of the various types of incompatible machine learning frameworks (e.g., TensorFlow, TensorFlow Lite, ONXX, and PyTorch), the universal compiler 210 may convert it into machine code that can be executed on the NPU or CPU within the edge device 1000 based on mapping information. The mapping information indicates mapping of elements of machine learning frameworks to functions or operations executable by hardware components (e.g., NPU or CPU) in an edge device. The elements of a machine learning framework refers to building blocks of a neural network model such as layers and activation functions.

The universal compiler may perform the following operations: converting from a machine learning framework-dependent model into a framework-independent model; converting the framework-independent model into a hardware-independent graph (e.g., intermediate representations (IR)); converting the hardware-independent graph into hardware-dependent code (e.g., code that converts the hardware-independent graph into a hardware processable code based on operations supported by target hardware); and converting the hardware-dependent code into machine code (e.g., binary code executable on the target hardware).

The mapping information may be utilized to convert a framework-dependent model to a framework-independent model and to convert hardware-independent graph information to hardware-dependent code. For this purpose, mapping information may further indicate, among others: mapping of elements of the framework-dependent model to elements of the framework-independent model, and mapping of elements of hardware-independent graph information to elements of hardware-dependent code. Additionally, it plays a role in converting information representing individual characteristics into a common representation and vice versa.

In other words, the mapping information may include information for performing one or more of these conversion steps or a collection thereof.

In one embodiment, the universal compiler may be configured to compile machine code for heterogenous processors (e.g., NPU and CPU). As an example, an edge-device including SoC may include heterogenous processors and the universal compiler may generate respective machine code for heterogenous processors based on a hardware-independent graph. For example, the first operation of the hardware-independent graph may be assigned to the CPU, while the second operation may be assigned to the NPU. As certain operations are more efficiently processed by the NPU, while others are more efficiently processed by the CPU.

Accordingly, the universal compiler may generate code suited for each target hardware (NPU and CPU) in the conversion step for the hardware-independent graph into a hardware-dependent code. Subsequently, the universal compiler generates code in the appropriate format for a respective target processor, incorporating hardware-specific operations throughout. Finally, the universal compiler consolidates the generated code into binaries capable of execution in a heterogeneous environment, encompassing CPU and NPU.

Moreover, NPUs are suited for handling computations associated with deep learning models, rendering them superior to CPUs in terms of both time and power efficiency. Consequently, NPUs offer advantages in computational cost and power efficiency over CPUs. However, in a heterogeneous environment where NPU and CPU exchange data for deep learning model computations, there is a transmission time and latency involved in data exchange, resulting in inefficiencies known as data exchange cost inefficiency. To mitigate such latency, the universal compiler prioritizes distributing operations to increase the computational cost advantage of the NPU while reducing data exchange costs. As a result, most operations may be assigned to the NPU, with the exception of operations that the NPU is incapable of handling, which may be assigned to the CPU by the universal compiler.

In one embodiment, the embedded universal compiler may further enhance performance by leveraging profiling data obtained from real-world operations. Variations in the system operating environment, such as fluctuations in operating clocks, bus delays, and frequency of operation requests, may be recorded and considered during compilation to optimize the cost of individual operations. For instance, if the cost of a particular operation is lower on the CPU based on the default optimization setting, which prioritizes operation specifics during the initial compilation, the operation will be executed on the CPU. However, if the CPU operates at a lower typical clock speed or if data exchange costs exceed predictions, the NPU will offer a computational cost advantage. In such cases, if the profiling data is incorporated into the subsequent compilation process to recalculate the compute cost, the operation will be executed on the NPU.

Machine learning framework-dependent model may be provided in different file types such as TensorFlow, TensorFlow Lite, ONXX, and PyTorch.

The mapping information may map elements or components (e.g., a layer) of various types of machine learning frameworks (e.g., TensorFlow, TensorFlow Lite, ONXX, and PyTorch) to functions or operations executable by hardware components such as NPUs (NPUs of different types) and CPUs (CPUs of different types).

The functions or operations executable by an NPU, as indicated in the mapping information, may include information about the internal memory 120 in the neural processing unit 100 (e.g., size of the internal memory, bit width of read/write operations to the internal memory, information regarding the type/structure/speed of the internal memory), information about whether integer or floating-point operations can be performed, and if so, how many bits of an integer can be processed (e.g., int8, and the like), floating-point operations, if so, how many bits of floating-point operations can be processed, information about the clock frequency for the operations, information about the number of PEs, types of special function units, and the like.

Further, the functions or operations executable by a CPU, as indicated in the mapping information, may depend on characteristics and the type of the CPU (e.g., X86 CPUs, ARM CPUs, RISC-V CPUs).

Further, the mapping information may indicate the combinations of NPUs (e.g., NPU A, NPU B, NPU C) and CPUs (e.g., X86 CPU, ARM CPU, RISC-V CPU) available in the edge device. The mapping information may indicate that the edge device has a certain combination of NPUs and CPUs (e.g., a combination of NPU A with an X86 CPU, a combination of NPU A with an ARM CPU, a combination of NPU A with a RISC-V CPU, a combination of NPU B with an X86 CPU, a combination of NPU B with an ARM CPU, a combination of NPU B with a RISC-V CPU).

The mapping information may include combination information of the NPU, the CPU, and the machine learning framework. The combination information may include, for example, information about combinations of the first series, combinations of the second series, and combinations of the third series. The combinations of the first series may include a combination of TensorFlow and NPU A with an X86 CPU, a combination of TensorFlow and NPU A with an ARM CPU, a combination of TensorFlow and NPU A with a RISC-V CPU, a combination of TensorFlow and NPU B with an X86 CPU, a combination of TensorFlow and NPU B with an ARM CPU, a combination of TensorFlow and NPU B with a RISC-V CPU, and the like. The combination of the second series may include a combination of a PyTorch and NPU A with an X86 CPU, a combination of a PyTorch and NPU A with an ARM CPU, a combination of a PyTorch and NPU A with a RISC-V CPU, a combination of a PyTorch and NPU B with an X86 CPU, a combination of a PyTorch and NPU B with an ARM CPU, a combination of a PyTorch and NPU B with a RISC-V CPU. The combinations of the third series may include a combination of ONXX and NPU A with an X86 CPU, a combination of ONXX and NPU A with an ARM CPU, a combination of ONXX and NPU A with a RISC-V CPU, a combination of ONXX and NPU B with an X86 CPU, a combination of ONXX and NPU B with an ARM CPU, a combination of ONXX and NPU B with a RISC-V CPU.

The universal compiler 210 may be configured to provide a plurality of compilation options.

The plurality of compilation options may vary according to different types of NPUs, so that the compiled machine code for the same neural network model may vary according to different types of NPUs and a respective machine code may be generated for each selected compilation option.

The universal compiler 210 may compile the neural network model into machine code based on a plurality of compilation options. According to examples of the present disclosure, an edge device comprising the universal compiler may be provided with a new neural network model and compile the neural network model on the edge device without requiring a separate external device.

According to examples of the present disclosure, an edge device including a universal compiler has, among others, the advantage of being able to generate machine code to be executed on an NPU included in the edge device without or with minimal intervention of a host device external to the edge device, even when a neural network model is changed, thereby providing a simple and fast user experience.

According to the examples of the present disclosure, even if the universal compiler does not communicate with a separate host device during the runtime of the edge device, the universal compiler can perform compilation independently, which has the advantage of enabling the edge device to operate independently in an environment with limited connectivity to a host.

The universal compiler 210 may include the optimizer 21-1, the verifier 21-2, and the code generator 21-3 in software form, as shown in FIG. 9. That is, the optimizer 21-1, the verifier 21-2, and the code generator 21-3 may be implemented as software and included within the universal compiler 210.

The optimizer 21-1 may optimize the neural network model based on a plurality of compilation options, as described with reference to FIG. 10.

The plurality of compilation options set by the optimizer 21-1 may be at least one of a pruning option, a quantization option, a retraining option, a model compression option, an AI based model optimization option, and a knowledge distillation option.

The pruning option can provide a technique for reducing the computation of a neural network model. The pruning algorithm may be configured to replace small values that are close to zero with zero among the weights of the layers of the neural network model. The plurality of neural processing units 100 can skip multiplication operations associated with zero weights, which can speed up convolutional computation and reduce power consumption, and reduce the parameter size of the machine code of a neural network model with the pruning option applied. Additionally, if a particular weight parameter is zeroed out by the pruning option, the pruning algorithm may provide substantially the same effect as disconnecting the connections in the neural network model with that weight data. For example, the pruning options may include a size-based first pruning option that removes the smallest weights and a percentage-based second pruning option that removes a certain percentage of the smallest weights.

The quantization option may provide a technique for reducing the size of the parameters of the neural network model. The quantization algorithm may be configured to selectively reduce the number of bits in the weights and feature maps of each layer of the neural network model. When a quantization option reduces the number of bits in a particular feature map and a particular weight, the quantization option may reduce the size of parameters in the machine code of the neural network model to which the quantization option is applied. For example, a 32-bit parameter representing a floating-point can be converted to a parameter with a bit width of 2 bits to 16 bits representing an integer when the quantization option is applied.

The model compression option may provide techniques for compressing the weight parameters of a neural network model, feature map parameters, and the like. The model compression technique may be implemented by utilizing any known compression technique in the art. This can reduce the parameter size of the machine code of a neural network model with the model compression option applied. The model compression option may optionally be provided to a neural processing unit comprising a decompression decoder of the plurality of neural processing units 100.

The knowledge distillation option may provide a technique for transferring knowledge from a complex model (e.g., the teacher model) to a smaller, simpler model (e.g., the student model). In a knowledge distillation algorithm, the teacher model typically has larger parameter sizes and higher accuracy than the student model. For example, in the retraining option described later, a neural network model trained with 32-bit floating-point parameters is set as the teacher model, and a neural network model with various optimization options is set as the student training model, and the accuracy of the student model can be improved with the knowledge distillation option. The student model may be a model with at least one of the following options selected: pruning option, quantization option, model compression option, and retraining option.

The retraining option is a technique that can compensate for degraded inference accuracy when applying various optimization options. For example, when applying the quantization option, pruning option, and model compression option, the accuracy of the neural network model inferred by the plurality of neural processing units 100 may be degraded. In such cases, an option may be provided to retrain the pruned, quantized, and/or model compressed neural network model online. Once retrained, the inference accuracy of the neural network model may be increased.

Specifically, the retraining option may include a quantization aware retraining option, a pruning aware retraining option, and a transfer learning option.

The quantization-aware retraining (QAT) option incorporates quantization into the training phase of a neural network model, where the model fine-tunes the weights to reflect quantization errors. The quantization-aware retraining algorithm may include a loss function, a gradient calculation function, and/or modifications on optimization algorithms. The quantization-aware retraining option can compensate for quantization errors by quantizing the trained neural network model and then performing fine-tuning to retrain the model in a way that minimizes the loss according to the quantization.

The pruning-aware retraining (PAT) option identifies and removes less important weights from the trained neural network model and then fine-tunes the remaining weights. Pruning criteria may utilize weight magnitude, activation values, sensitivity analysis, and the like. The pruning-aware retraining option can compensate for issues such as reducing the size of the neural network model, speeding up inference, and improving overfitting during retraining.

The transfer learning option may mean that the neural network model learns by transferring knowledge from one task to another related task. Transfer learning algorithms are effective when there is not enough data initially or when training a neural network model from scratch requires a lot of computational resources.

The universal compiler 210 may analyze the parameter information of each layer of the neural network model. The universal compiler 210 may analyze the size of the weight parameters and feature map parameters of each layer. The universal compiler 210 may analyze a connection relationship between the respective layers. The universal compiler 210 may analyze the size of the input parameters and output parameters of each layer. Here, the parameters of the multidimensional matrix may be referred to as tensors. The universal compiler 210 may analyze particular functions applied to each of the layers. The universal compiler 210 may analyze the branches of a particular layer. The universal compiler 210 may analyze the merge points of certain layers.

Further, the universal compiler 210 may analyze the non-graph-based function modules applied to each layer. Further, the universal compiler 210 may be configured to convert the non-graph-based function modules into graph-based modules so as to increase compatibility of the universal compiler 210 of the edge device 1000.

Non-graph-based functions included in each layer may include, for example, at least one of addition, subtraction, multiplication, division, convolution, matrix product, slice, concatenation, tensor view functions, reshape function, transpose function, softmax function, permute function, chunk function, split function, clamp function, flatten function, tensor mean function, and sum function. Additionally, the above functions may be provided as non-graph-based functions in a particular machine learning framework software. Here, the universal compiler 210 may be configured to explore said non-graph-based functions.

On the other hand, the edge device 1000 may be implemented in the form of a system on chip (SoC). An SoC may be a semiconductor that puts an entire system on a chip, and it refers to a technology in which major semiconductor devices such as computation memory data conversion devices are implemented on a single chip. SiP refers to a semiconductor that packages an entire system in a single package, and refers to a technology in which major semiconductor devices such as computation memory data conversion devices are implemented in a single package. “In other words, either one NPU 100 or a plurality of NPUs 100-1, 100-2, either one CPU 300 or a plurality of CPUs 300-1, 300-2, the universal compiler 210, one or more memories 200-1, 200-2, and the memory controller 250 may be connected to the system bus 500 on a single semiconductor die or substrate. By integrating them into a package, the chip or package itself becomes a unified system.”.

According to one example of the present disclosure, a system is provided. The system may comprise a substrate, a first circuit, disposed on the substrate, for a first memory, a second circuit, disposed on the substrate, for a neural processing unit (NPU) comprising a plurality of processing elements (PEs) including adders, multipliers, and accumulators, a controller, and a second memory, and a third circuit, disposed on the substrate, for a central processing unit (CPU). The CPU may be configured to execute a universal compiler to perform a conversion for a particular neural network model into a machine code executable by the NPU and store the machine code in the first memory or the second memory. When the particular neural network model, generated by one among a plurality of machine learning frameworks that are incompatible with each other, is received and stored in the first memory, the universal compiler may perform the conversion based on mapping information between information about the plurality of machine learning frameworks and characteristic information of the CPU or NPU.

According to one example of the present disclosure, an edge device is provided. The edge device may comprise a first memory, a first semiconductor chip for a neural processing unit (NPU) comprising a plurality of processing elements (PEs) including adders, multipliers, and accumulators, a controller, and a second memory, and a second semiconductor chip for a central processing unit (CPU). The CPU may be configured to execute a universal compiler to perform a conversion for a particular neural network model into a machine code executable by the NPU and store the machine code in the first memory or the second memory. When the particular neural network model, generated by one among a plurality of machine learning frameworks that are incompatible with each other, is received and stored in the first memory, the universal compiler may perform the conversion based on mapping information between information about the plurality of machine learning frameworks and characteristic information of the CPU or NPU.

The plurality of machine learning frameworks may include at least one among TensorFlow™, TensorFlow Lite™, PyTorch™, and ONNX™

The characteristic information of the NPU may include at least one of an internal memory size, a bitwidth of read or write operations to the internal memory, information on the internal memory type, structure or speed, information on whether integer and/or floating-point operations are supported, if the integer operations are supported, a supporting range of bitwidth for the integer operations, if the floating-point operations are supported, a supporting range of bitwidth for the floating-point operations, information on an operating frequency, information on a number of PEs, and information on SFU circuits (e.g., capability of the SFU circuits).

The characteristic information of the CPU may include at least one of X86, ARM, and RISC-V.

The particular neural network model may be received in a form of a computer file corresponding to a particular machine learning framework, which is not executable on the NPU prior to the conversion performed by the universal compiler.

The universal compiler may include at least one of an optimizer, a verifier, and a code generator.

The optimizer may include at least one of a pruning option, a quantization option, a retraining option, a model compression option, an AI based optimization option, and a knowledge distillation option.

The universal compiler may be configured to analyze parameter information of each layer of the particular neural network model.

The universal compiler may be configured to analyze sizes of weight parameters and feature map parameters of each layer in the particular neural network model.

The universal compiler may be configured to analyze connectivity between layers in the particular neural network model.

The examples of the present disclosure shown in the description and drawings are provided for the purpose of illustrating the technical content of the present disclosure and to facilitate understanding of the present disclosure, and are not intended to limit the scope of the disclosure. The technical features of each example of the present disclosure can be combined with the technical features of other examples. It will be apparent to one of ordinary skill in the art to which this disclosure belongs that other variations of the examples described above are possible.

### National Research and Development Project that Supported this Invention

[symbol] Assignment number [symbol] 1711193247
[symbol] Assignment number [symbol] 2022-0-00248-002
[symbol] Ministry Name [symbol] Ministry of Science and ICT
[symbol] Name of project management (professional) organization [symbol] Information and Communications Planning and Evaluation Institute
[symbol] Research project name [symbol] PIM artificial intelligence semiconductor core technology development (design)
[symbol] Research project name [symbol] Development of CXL-based PIM semiconductor technology for multiple DRAM modules considering memory consistency
[symbol] Name of project carrying out organization [symbol] DeepX Co., Ltd.
[symbol] Research period [symbol] 2023.01.01˜2023.12.31

What is claimed is:

1. An integrated circuit comprising:
a neural processing unit (NPU) comprising a plurality of processing elements (PEs), each of the PEs comprising a multiplier-accumulator circuit configured to perform multiply-accumulate operations;
a central processing unit (CPU) coupled to the NPU; and
one or more memory circuits coupled to the NPU and the CPU, the one or more circuits storing instructions, when executed by the CPU, cause the CPU to:
compile a first neural network model of a first machine learning framework incompatible with the NPU into first machine code executable by the NPU, according to first mapping information representing mapping of elements of the first machine learning framework to functions or operations executable on at least one of the NPU or the CPU,
store the first machine code, and
send the first machine code to the NPU for execution.

2. The integrated circuit of claim 1, wherein the instructions, when executed by the CPU, cause the CPU to:
compile a second neural network model of a second machine learning framework incompatible with the NPU into second machine code executable by the NPU, according to second mapping information representing mapping of the second machine learning framework to the configuration of at least one of the NPU or the CPU,
store the second machine code, and
send the second machine code to the NPU for execution.

3. The integrated circuit of claim 1, wherein the configuration of the NPU further includes at least one of:
an internal memory size of the NPU;
a bitwidth of read or write operations associated with the one or more memory circuit;
a type, structure or speed of the one or more memory circuit;
types of number formats supported by the NPU;
a range of bitwidth supported for integer operations or floating-point operations;
an operating frequency of the NPU;
a number of the plurality of PEs; or
capability of special function unit circuits in the NPU.

4. The integrated circuit of claim 1, wherein the instructions causing the CPU to compile the first neural network model into the first machine code cause the CPU to:
convert the first neural network model into a framework-independent model,
convert the framework-independent model into a hardware-independent graph,
convert the hardware-independent model into a hardware-dependent code, and
convert the hardware-dependent code into the first machine code.

5. The integrated circuit of claim 1, wherein the instructions to compile the first neural network cause the CPU to perform at least one of optimizing or verification of the machine code.

6. The integrated circuit of claim 5, wherein the instructions to optimize the machine code cause the CPU to perform at least one of: perform pruning, perform quantization, perform retraining, perform compression, perform an artificial intelligence (AI)-based optimization algorithm, or perform knowledge distillation.

7. The integrated circuit of claim 1, wherein the instructions to compile the first neural network cause the CPU to analyze parameter information of each layer of the first neural network model.

8. The integrated circuit of claim 1, wherein the instructions to compile the first neural network cause the CPU to analyze sizes of weight parameters and feature map parameters of each layer in the first neural network model.

9. The integrated circuit of claim 1, wherein the instructions to compile the first neural network cause the CPU to analyze connectivity between layers in the first neural network model.

10. A non-transitory computer readable storage medium storing instructions thereon, the instructions when executed by a central processing unit (CPU) cause the CPU to:
store first mapping information representing mapping of elements of a first machine learning framework to functions or operations executable by at least one of a neural processing unit (NPU) or the CPU;
compile a first neural network model of a first machine learning framework incompatible with the NPU into first machine code executable by the NPU, according to the first mapping information, wherein the NPU, the CPU and the non-transitory computer readable storage medium are integrated into an integrated circuit;
store the first machine code in the non-transitory computer readable storage medium; and
send the first machine code to the NPU for execution.

11. The non-transitory computer readable storage medium of claim 10, wherein the NPU comprises a plurality of processing elements (Pes), each of the Pes comprising a multiplier-accumulator circuit configured to perform multiply-accumulate operations.

12. The non-transitory computer readable storage medium of claim 10, wherein the instructions causing the CPU to compile the first neural network model into the first machine code cause the CPU to:
convert the first neural network model into a framework-independent model,
convert the framework-independent model into a hardware-independent graph,
convert the hardware-independent model into a hardware-dependent code, and
convert the hardware-dependent code into the first machine code.

13. The non-transitory computer readable storage medium of claim 10, wherein the instructions, when executed by the CPU, cause the CPU to:
store second mapping information representing mapping of elements of a second machine learning framework to the functions or operations of at least one of the NPU or the CPU;
compile a second neural network model of the second machine learning framework incompatible with the NPU into second machine code executable by the NPU according to the second mapping information;
store the second machine code in the non-transitory computer readable storage medium; and
send the second machine code to the NPU for execution.

14. The non-transitory computer readable storage medium of claim 10, wherein the instructions to compile the first neural network cause the CPU to perform at least one of optimizing or verification of the machine code.

15. The non-transitory computer readable storage medium of claim 14, wherein the instructions to optimize the machine code cause the CPU to perform at least one of: perform pruning, perform quantization, perform retraining, perform compression, perform an artificial intelligence (AI)-based optimization algorithm, or perform knowledge distillation.

16. The non-transitory computer readable storage medium of claim 10, wherein the instructions to compile the first neural network cause the CPU to analyze parameter information of each layer of the first neural network model.

17. The non-transitory computer readable storage medium of claim 10, wherein the instructions to compile the first neural network cause the CPU to analyze sizes of weight parameters and feature map parameters of each layer in the first neural network model.

18. The non-transitory computer readable storage medium of claim 10, wherein the instructions to compile the first neural network cause the CPU to analyze connectivity between layers in the first neural network model.

19. A method, comprising:
storing first mapping information representing mapping of elements of a first machine learning framework to functions or operations executable by at least one of a neural processing unit (NPU) or a central processing unit (CPU) in one or more memory circuits, wherein the NPU, the CPU and the one or more memory circuits are included in an integrated circuit;
compiling a first neural network model of a first machine learning framework incompatible with the NPU into first machine code executable by the NPU according to the first mapping information;
storing the first machine code in the one or more memory circuits; and
sending the first machine code from the one or more memory circuits to the NPU for execution.

20. The method of claim 19, further comprising:
storing second mapping information representing mapping of elements of a second machine learning framework to the functions or operations of at least one of the NPU or the CPU;
compiling a second neural network model of the second machine learning framework incompatible with the NPU into second machine code executable by the NPU according to the second mapping information;
storing the second machine code in the one or more memory circuits; and
sending the second machine code to the NPU for execution.

21. The method of claim 19, wherein compiling the first neural network comprises performing at least one of optimizing or verification of the machine code.

22. The method of claim 19, wherein compiling the first neural network model into the first machine code comprises:
converting the first neural network model into a framework-independent model,
converting the framework-independent model into a hardware-independent graph,
converting the hardware-independent model into a hardware-dependent code, and
converting the hardware-dependent code into the first machine code.
